(19) United States
(12) Patent Application Publication
(10) Pub. No.: US 2018/0041563 A1
(43) Pub. Date: Feb. 8, 2018

(54) ENHANCED MULTIFUNCTIONAL COMPUTING DEVICE

(71) Applicant: Koji Yoden, Tamba (JP)

(72) Inventor: Koji Yoden, Tamba (JP)

(21) Appl. No.: 15/663,740

(22) Filed: Jul. 29, 2017

Related U.S. Application Data
(60) Provisional application No. 62/371,212, filed on Aug. 5, 2016.

(51) Int. Cl. H04L 29/08; G06F 3/0484; G06F 17/30; G06F 17/22

(52) U.S. Cl. CPC H04L 67/02; G06F 17/2235; G06F 3/04847; G06F 17/30902

(57) ABSTRACT

In an aspect, collaboration of first and second browsers respectively resident on first and second computing devices is disclosed. A first world wide web (WWW) browser on a first computing device, such as a portable smartphone carried by a user outdoors, responds to a user request for download of a media content from an online resource by requesting a second WWW browser on a second computing device, such as a personal computer located at a user's home, to locally download the media content over network. In another aspect, improved retrieval of web pages by a WWW browser is disclosed. The WWW browser automatically and preliminarily retrieves and cashes other one or more web pages hyperlinked to a web page in parallel to rendering the web page, for speedy access to the cashed web pages. In another aspect, improved graphical user interfaces for control of playback in a media player in a computing device having a sensitive display configured to detect hover of a physical object such as a user's finger or stylus above the sensitive display, are disclosed. The media player provides a first progress bar through which to control playback during playback of a media content, and also provides a second progress bar for detailed control of playback that appears adjacent to the first progress bar in response to detecting hover of the physical object being kept above the first progress bar.

### CROSS REFERENCE TO RELATED APPLICATIONS

This application claims the benefit of U.S. provisional patent application 62/371,212 filed on Aug. 5, 2016 and entitled “Enhanced Multifunctional Computing Device”, the content of which is incorporated herein by reference in its entirety.

### TECHNICAL FIELD

The present disclosure relates to an enhanced multifunctional computing device with enhancement of usability in media content playback and/or with enhancement of collaboration with another computing device over network.

### BACKGROUND

There have been marketed computing devices such as PCs (Personal Computers), laptops, mobile phones, and tablets. Such computing device nowadays has one or more great memories and one or more great processors, thereby becoming multi-functional with various computer programs executable on the device. Such computer programs may include, for example, a text editor, a World Wide Web (WWW) browser, a media player for playing back media contents, and video games. Enhancement and improvement have been made to the computing devices in various aspects, for example, including incorporation of a touch screen in a computing device for more intuitive user interface and collaboration with another computing device over the Internet or other networks for remote control of the another device by the computing device.

An object of the technologies disclosed herein is to provide a more enhanced multifunctional computing device that provides more attractive, enhanced, and/or improved user experiences.

### SUMMARY

An aspect of the present disclosure is a collaboration of first and second browsers respectively resident on first and second computing devices. The first browser on the first device is operative to respond to a user request for download of a media content resident on an online resource by issuing a download request to the second browser on the second device over network for download of the requested media content. In response to the download request issued by the first browser, the second browser then establishes a network communication with the online resource to download the requested media content onto a local storage of the second device. The download request may include a uniform resource identifier (URI) identifying the online resource so that the second browser may generate a download request, for example, in a Hypertext Transfer Protocol (HTTP) format. This aspect of the present disclosure may be advantageous in that a user is able to download a media content from an online resource onto a second computing device, such as a desktop computer located at home, using a first computing device, such as a mobile smartphone carried by the user outside the home.

Another aspect of the present disclosure is improved fetch or retrieval of hypertext web pages in a world wide web (WWW) browser. The browser uses a “look-ahead” cashing to voluntarily retrieve and cash on a memory one or more web pages hyperlinked to a web page when rendering the web page, without waiting for a user to select a hyperlink to one of the hyperlinked web pages. In response to the user's input to select a hyperlink to one of the hyperlinked web pages, the selected hyperlinked web page is read out of the cash to be instantly rendered on the WWW browser. This aspect of the present disclosure may be advantageous in making rendering of hyperlinked web pages speedy without the need of retrieval of the selected hyperlinked web page in response to the user's selection of the hyperlink.

Another aspect of the present disclosure is improvement in a graphical user interface for control, such as fast-forwarding and rewinding, of playback in a media player of a computing device with a sensitive display. The computing device uses an approach of detecting hover of a physical object such as a user's finger and stylus above the sensitive display and a tap of the physical object onto the sensitive display. The media player enables control of playback using a first progress bar, and also enables control of playback using a second progress bar that appears adjacent to the first progress bar in response to detecting hover of the physical object being kept above the first progress bar for more than a predetermined time period. The second progress bar allows detailed control of playback than the first progress bar. This aspect of the present disclosure may be advantageous in that the user is able to make detailed control of playback by activating the second progress bar by hovering his/her finger or stylus above the screen of the media player.

### DRAWINGS

FIG. 1 is a schematic view illustrating an exemplary system for improved downloading according to some embodiments.

FIG. 2 is a block diagram illustrating an exemplary configuration of a first computing device 100 in the system according to some embodiments.

FIG. 3 is a block diagram illustrating an exemplary configuration of a second computing device 200 in the system according to some embodiments.

FIG. 4 is a block diagram illustrating an exemplary configuration of a WWW sever computer 300 in the system according to some embodiments.

FIG. 5 illustrates databases 122, 222, and 322 stored in the first computing device 100, second computing device 200, and the server computer 300 respectively, each associating the identifiers of the first and second computing devices 100 and 200 with one another, according to some embodiments.

FIG. 6 is a flowchart illustrating a method 30 for associating the first and second computing devices 100 and 200 with one another, according to some embodiments.

FIG. 7 is a schematic view illustrating a graphical user interface through which to input the identifier of the second computing device 200, according to some embodiments.

FIG. 8 is a flowchart illustrating a method 40 for associating the first and second computing devices 100 and 200 with one another, according to some embodiments.

FIG. 9 is a flowchart illustrating a method 50 for associating the first and second computing devices 100 and 200 with one another, according to some embodiments.

FIG. 10 is a schematic view illustrating a graphical user interface through which to input the identifier of the first computing device 100, according to some embodiments.

FIG. 11 is a flowchart illustrating a method 60 for associating the first and second computing devices 100 and 200 with one another, according to some embodiments.

FIG. 12 is a flowchart illustrating a method 70 for associating the first and second computing devices 100 and 200 with one another, according to some embodiments.

FIG. 13 is a schematic view illustrating a graphical user interface through which to input the identifiers of the first and second computing devices 100 and 200, according to some embodiments.

FIG. 14 is a flowchart illustrating a method 80 for associating the first and second computing devices 100 and 200 with one another, according to some embodiments.

FIG. 15A is a schematic view illustrating a graphical user interface through which to input the identifier of the first computing device 100, according to some embodiments.

FIG. 15B is a schematic view illustrating a graphical user interface through which to input the identifier of the second computing device 200, according to some embodiments.

FIG. 16 illustrates an exemplary directory configuration with multiple directories in the second computing device 200, according to some embodiments.

FIG. 17 is a flowchart illustrating a method 140 for inquiring the directory configuration by the WWW browser 121, according to some embodiments.

FIG. 18 is a schematic view illustrating communications among the first computing device 100, second computing device 200, and the WWW server computer 300 for improved downloading, according to some embodiments.

FIG. 19 is a flowchart illustrating a method 400 for the improved downloading, according to some embodiments.

FIG. 20 is a schematic view illustrating a web page 330 displayed on the WWW browser 121, according to some embodiments.

FIG. 21 is a schematic view illustrating a dialog 124 displayed on the WWW browser 121, according to some embodiments.

FIGS. 22A and 22B illustrate a database 223 associating every directory of the second computing device 200 with permission or non-permission for access, according to some embodiments.

FIG. 23 is a flowchart illustrating a method 420 for the improved downloading according to some embodiments.

FIG. 24 is a flowchart illustrating a method 440 for the improved downloading according to some embodiments.

FIG. 25 is a flowchart illustrating a method 460 for the improved downloading according to some embodiments.

FIG. 26 is a flowchart illustrating “push” operation (S449, S469) described in the methods 440 and 450 according to some embodiments.

FIG. 27 illustrates an exemplary structure of hyperlinked webpages according to some embodiments.

FIG. 28 is a flowchart illustrating a method 500 for improved webpage retrieval according to some embodiments.

FIG. 29 is a flowchart illustrating a method 510 for improved webpage retrieval according to some embodiments.

FIG. 30 is a block diagram illustrating an exemplary configuration of a first computing device 100 including a media player, according to some embodiments.

FIG. 31 schematically illustrates a media content and metadata that are stored in association with each other on a memory of the first computing device 100 according to some embodiments.

FIG. 32 is a flowchart illustrating a method 600 for improved display of graphical user interfaces in the media player of the first computing device 100 according to some embodiments.

FIG. 33 schematically illustrates a first graphical user interface in the media player of the first computing device 100 for presenting media contents, according to some embodiments.

FIG. 34 schematically illustrates a second graphical user interface in the media player of the first computing device 100 for control of playback using a first progress bar, according to some embodiments.

FIG. 35 schematically illustrates a third graphical user interface in the media player of the first computing device 100 for control of playback using first and second progress bars, according to some embodiments.

FIG. 36 schematically illustrates another example of the third graphical user interface in the media player of the first computing device 100, according to some embodiments.

FIG. 37 schematically illustrates another example of the third graphical user interface in the media player of the first computing device 100, according to some embodiments.

FIGS. 38A and 38B schematically illustrate the second and third graphical user interfaces in the media player of the first computing device 100 that are displayed in a manner that a playback field on which playback is provided is downsized as the second graphical user interface is switched to the third graphical user interface.

FIGS. 39A and 39B schematically illustrate the second and third graphical user interfaces in the media player of the first computing device 100 that are displayed in a manner that a playback field on which playback is provided is substantially unchanged or constant as the second graphical user interface is switched to the third graphical user interface.

### DETAILED DESCRIPTION

Embodiments of the present invention are described with reference to the drawings. The embodiments described herein are for illustrative purpose only and not intended to limit the scope of protection defined by Claims.

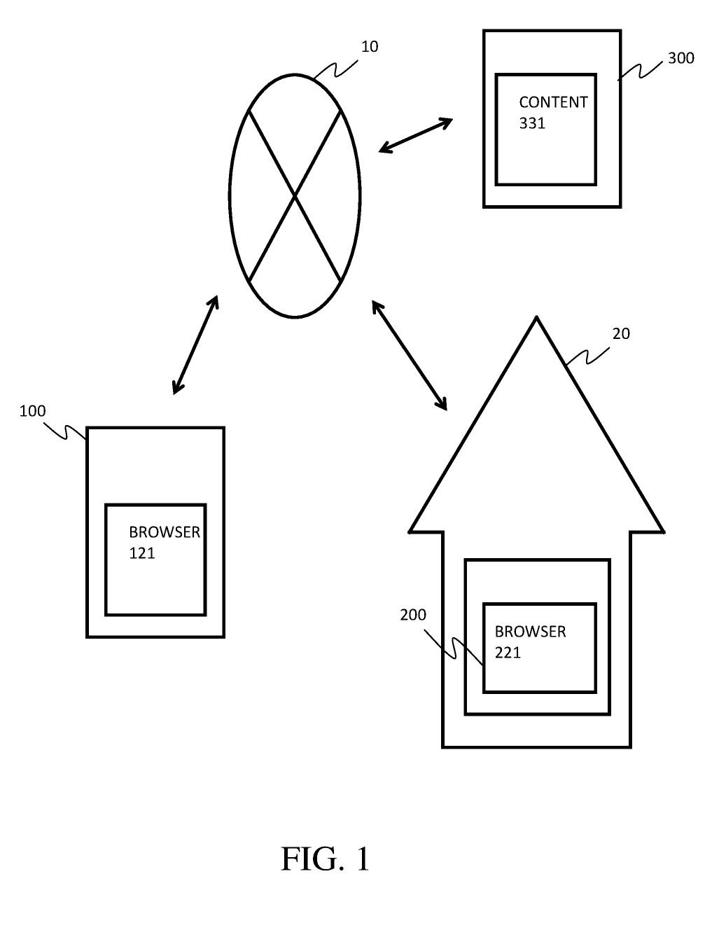

In some embodiments, a system 1 includes a first computing device 100 and a second computing device 200 that may be in communication with one another over a network 10. The computing device 100 may be a computing device having a first World Wide Web (WWW) browser 121 installed thereon, such as a personal computer (PC), tablet computer, smartphone, cellular phone, or any kind of other device or apparatus. The computing device 200 may be a computing device having a second WWW browser 221 installed thereon, such as a personal computer (PC), tablet computer, smartphone, cellular phone, or any kind of other device or apparatus. The network 10 provides a WWW environment under which web resources are hyperlinked according to Hypertext Transfer Protocol (HTTP). The network 10 may be the Internet. The system 1 further includes a WWW server computer 300 that may be in communication with the first and second computing devices 100 and 200 over the network 10. The server computer 300 stores one or more contents 331 each of which is located at a particular location identified by a uniform resource identifier (URI) such as a uniform resource locator (URL). The first computing device 100, the second computing device 200, and the server computer 300 are addressed with discrete identifiers for each to be a distinguished individual on the network 10, namely, for example, may be assigned discrete and different IP addresses on the network 10. One of the first and second computing devices 100 and 200 (the first device 100 in the example of FIG. 1) may be a mobile or portable device suitable to be carried outside by a user while the other (the second device 200 in the example of FIG. 1) may normally reside, or be placed or installed within a facility 20 such as a user's house.

### <First Device>

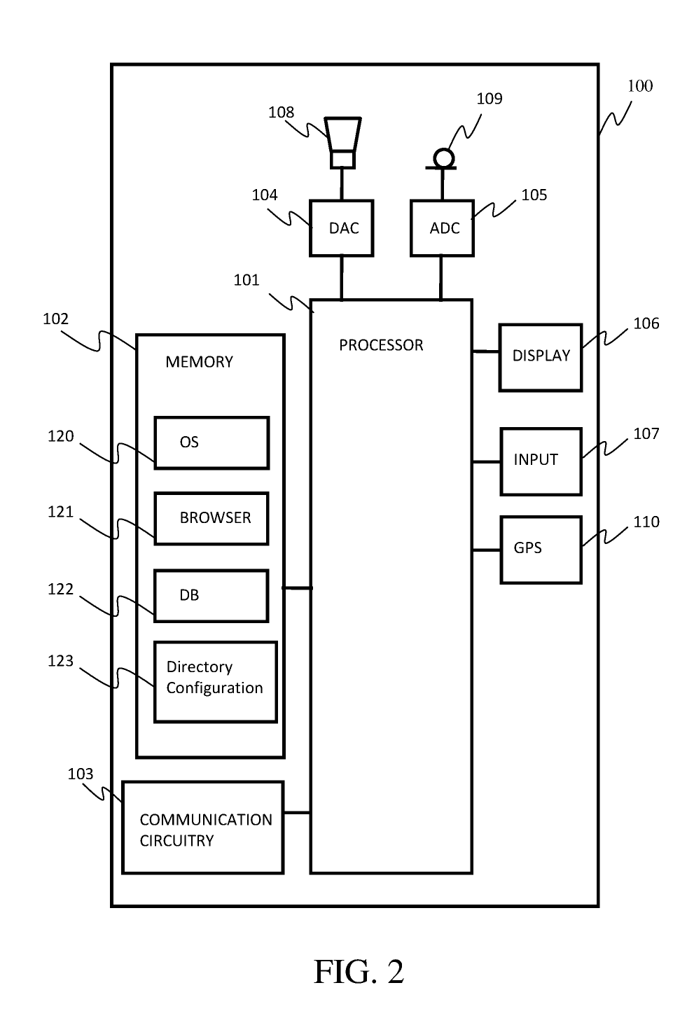

In some embodiments, as depicted in FIG. 2, the first computing device 100 includes a processor 101, a memory 102, communication circuitry 103, a digital-to-analog converter (DAC) 104, an analog-to-digital converter 105 (ADC), a loudspeaker 108, a microphone 109, a display 106, an input unit 107, and a global positioning system 110. The first computing device 100 may be a smart phone, a cell phone, a tablet computer, a laptop computer, or one of other computing devices designed or adopted for portability. The processor 101 is a processing unit operative to execute computer programs resident on the memory 102 to process various data and to control the components 102 to 110 coupled to the processor 101. The processor 101 may be a central processing unit (CPU), a micro processing unit (MPU), a digital signal processor (DSP), another general or dedicated processing unit, or combination thereof. The memory 102 is coupled to the processor 101 and is operative to store one or more computer programs and/or various data for execution and/or use by the processor 101. The memory 102 may be a read only memory (ROM), a random access memory (RAM), another memorizing component or computer-readable medium, or combination thereof. In some embodiments, the memory 102 stores at least an operating system (OS) 120, a WWW browser 121, a database (DB) 122, and directory configuration information 123. The WWW browser 121 is an application program configured to run on the OS 120 or part of the OS 120, to request for such a web resource as a web page described in a Hypertext format on the server computer 300 using HTTP and render the web resource. The DB 122 includes information indicative of the identifier on the network 10 for the first computing device 100 and the identifier on the network 10 for the second computing device 200 being associated with one another. Each identifier may be an IP address for identifying corresponding one of the devices on the network 10. In other words, the first computing device 100 and the second computing device 200 may be distinctive from one another with discrete IP addresses. The directory configuration information 123 indicates the configuration or structure of one or more directories of the second computing device 200. The communication circuitry 103 is coupled to the processor 101 and is operative to perform a wired and/or wireless communication in accordance with at least one wired and/or wireless communication standard for connection to the network 10. The communication circuitry 103 may be a single circuit designed to perform a communication in compliance with a single communication standard, or may be one or more single or combined circuits designed to perform communication in compliance with multiple communication standards. The wired communication herein may include a local area network (LAN) or Ethernet communication in accordance with IEEE 802.3 standards. The wireless communication herein may include a wireless local area network (WLAN) or Wi-Fi communication in accordance with IEEE 802.11 standards; a wireless personal area network (WPAN) communication such as the Bluetooth and ZigBee in accordance with IEEE 802.15 standards, a RFID communication, a NFC, a ultrasonic communication, an IR communication, and the likes; and a cellular communication over a cellular network such as a 3G, 4G, or 5G network, for example. The DAC 104 is coupled to the processor 101 and the loudspeaker 108. The DAC 104 is operative to convert digital audio data processed by the processor 101 into analog audio signals and then feed the analog audio signals to the loudspeaker 108. The loudspeaker 108 is operative to output the analog audio signals received from the DAC 104, as sound. The microphone 109 is operative to pick up sound and feed analog audio signals of the sound to the ADC 105. The ADC 105 is coupled to the microphone 109 and the processor 101. The ADC 105 is operative to convert the analog audio signals received from the microphone 109 into digital audio data and feed the digital audio data to the processor 101. The display 106 is coupled to the processor 101. The display 106 is operative to receive, from the processor 101, graphical data processed by the processor 101 to display graphical screen based on the graphical data. For example, the display 106 may display a web page rendered by the processor 101 based on the WWW browser 121. The display 106 may be a liquid crystal display (LCD), an electro-luminance (EL) display, or another similar type of display device. The input 107 is coupled to the processor 101. The input 107 is operative to receive a user input made through the input 107 and feed signals indicative of the user input to the processor 101. The input 107 may be a keyboard or keypad with a plurality of mechanical keys. The input 107 may be a touch sensitive device integrated with the display 106, in which case the display 106 and the input 107 together constitute a touch sensitive display operative to detect touches or taps made by a user onto the surface of the touch sensitive display and feed signals indicative of the touches or taps to the processor 101. The GPS module 110 is circuitry operative to receive position information indicative of a geographical position in which the portable computing device 100 is present, based on the global positioning system (GPS).

### <Second Device>

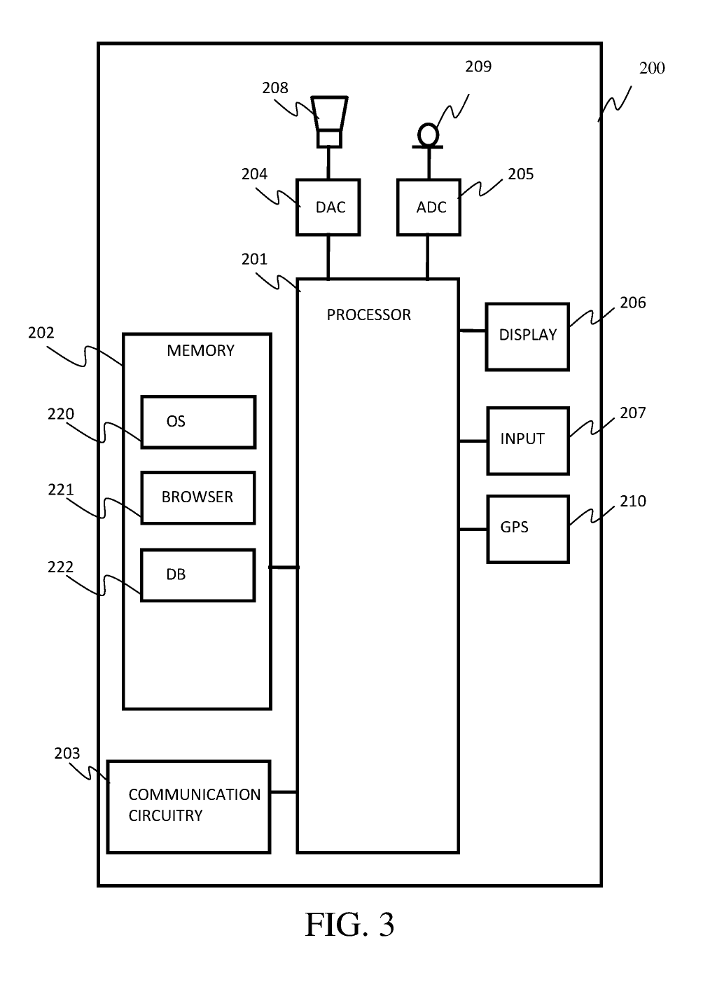

In some embodiments, as depicted in FIG. 3, the second computing device 200 includes a processor 201, a memory 202, communication circuitry 203, a digital-to-analog converter (DAC) 204, an analog-to-digital converter 205 (ADC), a loudspeaker 208, a microphone 209, a display 206, an input unit 207, and a global positioning system 210. The second computing device 200 may be a smart phone, a cell phone, a tablet computer, a laptop computer, or one of other computing devices designed or adopted for portability. The processor 201 is a processing unit operative to execute computer programs resident on the memory 202 to process various data and to control the components 202 to 210 coupled to the processor 201. The processor 201 may be a central processing unit (CPU), a micro processing unit (MPU), a digital signal processor (DSP), another general or dedicated processing unit, or combination thereof. The memory 202 is coupled to the processor 201 and is operative to store one or more computer programs and/or various data for execution and/or use by the processor 201. The memory 202 may be a read only memory (ROM), a random access memory (RAM), another memorizing component or computer-readable medium, or combination thereof. In some embodiments, the memory 202 stores at least an operating system (OS) 220, a WWW browser 221, and a database (DB) 222. The WWW browser 221 is an application program configured to run on the OS 220 or part of the OS 220, to request for such a web resource as a web page described in a Hypertext format on the server computer 300 using HTTP and render the web resource. The DB 222 includes information indicative of the identifier on the network 10 for the first computing device 100 and the identifier on the network 10 for the second computing device 200 being associated with one another. Each identifier may be an IP address for identifying corresponding one of the devices on the network 10. The communication circuitry 203 is coupled to the processor 201 and is operative to perform a wired and/or wireless communication in accordance with at least one wired and/or wireless communication standard for connection to the network 10. The communication circuitry 203 may be a single circuit designed to perform a communication in compliance with a single communication standard, or may be one or more single or combined circuits designed to perform communication in compliance with multiple communication standards. The wired communication herein may include a local area network (LAN) or Ethernet communication in accordance with IEEE 802.3 standards. The wireless communication herein may include a wireless local area network (WLAN) or Wi-Fi communication in accordance with IEEE 802.11 standards; a wireless personal area network (WPAN) communication such as the Bluetooth and ZigBee in accordance with IEEE 802.15 standards, a RFID communication, a NFC, a ultrasonic communication, an IR communication, and the likes; and a cellular communication over a cellular network such as a 3G, 4G, or 5G network, for example. The DAC 204 is coupled to the processor 201 and the loudspeaker 208. The DAC 204 is operative to convert digital audio data processed by the processor 201 into analog audio signals and then feed the analog audio signals to the loudspeaker 208. The loudspeaker 208 is operative to output the analog audio signals received from the DAC 204, as sound. The microphone 209 is operative to pick up sound and feed analog audio signals of the sound to the ADC 205. The ADC 205 is coupled to the microphone 209 and the processor 201. The ADC 205 is operative to convert the analog audio signals received from the microphone 209 into digital audio data and feed the digital audio data to the processor 201. The display 206 is coupled to the processor 201. The display 206 is operative to receive, from the processor 201, graphical data processed by the processor 201 to display graphical screen based on the graphical data. For example, the display 206 may display a web page rendered by the processor 201 based on the WWW browser 221. The display 206 may be a liquid crystal display (LCD), an electro-luminance (EL) display, or another similar type of display device. The input 207 is coupled to the processor 201. The input 207 is operative to receive a user input made through the input 107 and feed signals indicative of the user input to the processor 201. The input 207 may be a keyboard or keypad with a plurality of mechanical keys. The input 207 may be a touch sensitive device integrated with the display 206, in which case the display 206 and the input 207 together constitute a touch sensitive display operative to detect touches or taps made by a user onto the surface of the touch sensitive display and feed signals indicative of the touches or taps to the processor 201. The GPS module 210 is circuitry operative to receive position information indicative of a geographical position in which the portable computing device 200 is present, based on the global positioning system (GPS).

<WWW Server>

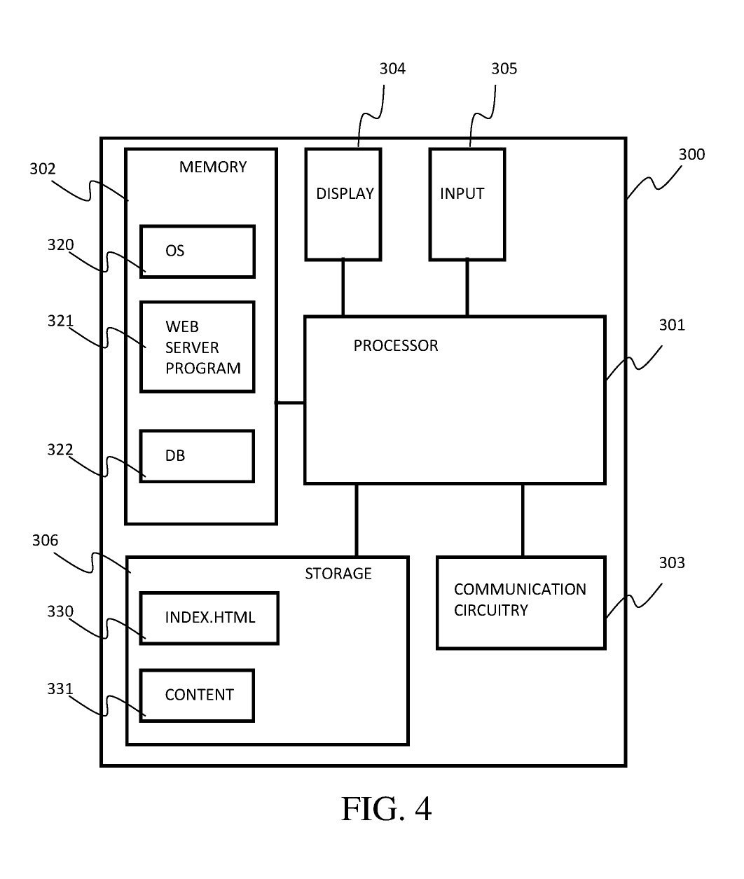

In some embodiments, as depicted in FIG. 4, the WWW server computer 300 includes a processor 301, a memory 302, communication circuitry 303, a display 304, an input unit 305, and a storage 306. The WWW server computer 300 may be a desktop computer, a workstation, a tablet computer, a laptop computer, or one of other computing devices designed or adopted for operation as a web server. The processor 301 is a processing unit operative to execute computer programs resident on the memory 302 to process various data and to control the components 302 to 306 coupled to the processor 301. The processor 301 may be a central processing unit (CPU), a micro processing unit (MPU), a digital signal processor (DSP), another general or dedicated processing unit, or combination thereof. The memory 302 is coupled to the processor 301 and is operative to store one or more computer programs and/or various data for execution and/or use by the processor 301. The memory 302 may be a read only memory (ROM), a random access memory (RAM), another memorizing component or computer-readable medium, or combination thereof. In some embodiments, the memory 302 stores at least an operating system (OS) 320, a WWW server program 321, and a database (DB) 322. The WWW program 321 is an application program configured to run on the OS 320 or part of the OS 320, to transfer web resources resident on the storage 306 using HTTP in response to a request by the WWW browser 121 or 221. The DB 322 includes information indicative of the identifier on the network 10 for the first computing device 100 and the identifier on the network 10 for the second computing device 200 being associated with one another. Each identifier may be an IP address for identifying corresponding one of the devices on the network 10. The storage 306 is coupled to the processor 301 and is operative to store a web resource accessible by the WWW browser 121 and 221. The storage 306 may be a read only memory (ROM), a random access memory (RAM), another memorizing component or computer-readable medium, or combination thereof. The storage 306 may be physically integrated with the memory 203, part of the memory 302, or physically apart from the memory 302. In some embodiments, the storage 306 stores at least one web page 330 described in a Hypertext Markup Language (HTML) format and at least one content 331 hyperlinked to the web page 330. The content 331 may be a music content formatted in, for example, MPEG-1 Audio Layer-3 (MP3); an image content formatted in, for example, Joint Photographic Experts Group (JPEG); a video content formatted in, for example, Moving Picture Experts Group-4 (MPEG-4); or the like in any form. The communication circuitry 303 is coupled to the processor 301 and is operative to perform a wired and/or wireless communication in accordance with at least one wired and/or wireless communication standard for connection to the network 10. The communication circuitry 303 may be a single circuit designed to perform a communication in compliance with a single communication standard, or may be one or more single or combined circuits designed to perform communication in compliance with multiple communication standards. The wired communication herein may include a local area network (LAN) or Ethernet communication in accordance with IEEE 802.3 standards. The wireless communication herein may include a wireless local area network (WLAN) or Wi-Fi communication in accordance with IEEE 802.11 standards; a wireless personal area network (WPAN) communication such as the Bluetooth and ZigBee in accordance with IEEE 802.15 standards, a RFID communication, a NFC, a ultrasonic communication, an IR communication, and the likes; and a cellular communication over a cellular network such as a 3G, 4G, or 5G network, for example. The display 304 is coupled to the processor 301. The display 304 is operative to receive, from the processor 301, graphical data processed by the processor 301 to display graphical screen based on the graphical data. The display 304 may be a liquid crystal display (LCD), an electro-luminance (EL) display, or another similar type of display device. The input 305 is coupled to the processor 301. The input 305 is operative to receive a user input made on the input 305 and feed signals indicative of the user input to the processor 301. The input 305 may be a keyboard or keypad with a plurality of mechanical keys. The input 305 may be a touch sensitive device integrated with the display 304, in which case the display 304 and the input 305 together constitute a touch sensitive display operative to detect touches or taps made by a user onto the surface of the touch sensitive display and feed signals indicative of the touches or taps to the processor 301.

<DB122>

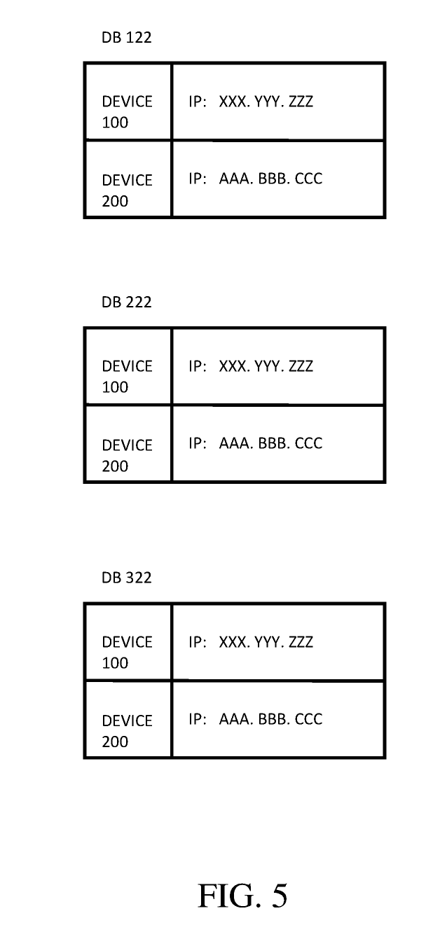

In some embodiments, as depicted in FIG. 5, the identifier of the first computing device 100 such as its IP address (e.g., XXX.YYY.ZZZ) and the identifier of the second computing device 200 such as its IP address (e.g., AAA.BBB.CCC) are associated with each other in the DB 122, 222, and 322.

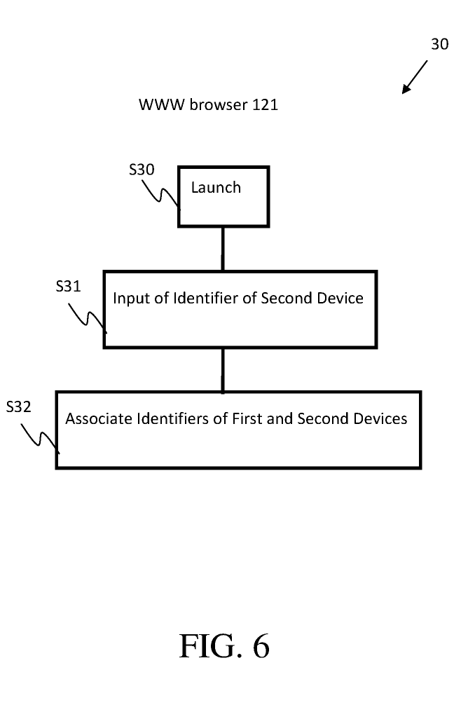

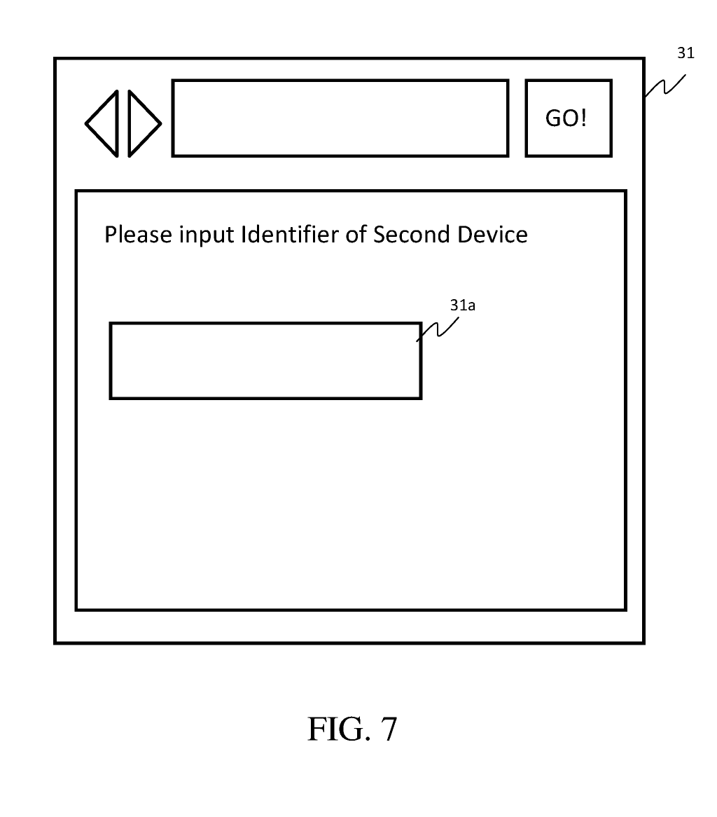

In some embodiments, the DB 122 may be generated according to a method 30 as depicted in FIG. 6. Referring to FIG. 6, the method 30 may include launching the WWW browser 121 by the first computing device 100 in response to a user input through the input unit 107 (S30); the WWW browser 121 displaying, on the display 106, a graphical user interface (GUI) 31 through which to receive a user manual input of the identifier (e.g., IP address) of the second computing device 200 (S31). The GUI 31 may include an input field 31a prompting the user to input the identifier, as depicted in FIG. 7. The method 30 may include, in response to input of the identifier of the second computing device 200, the WWW browser 121 associating the inputted identifier with the identifier (e.g. IP address) of the first computing device 100 (S32). As a result of the association at s S32, the DB 122 may be generated.

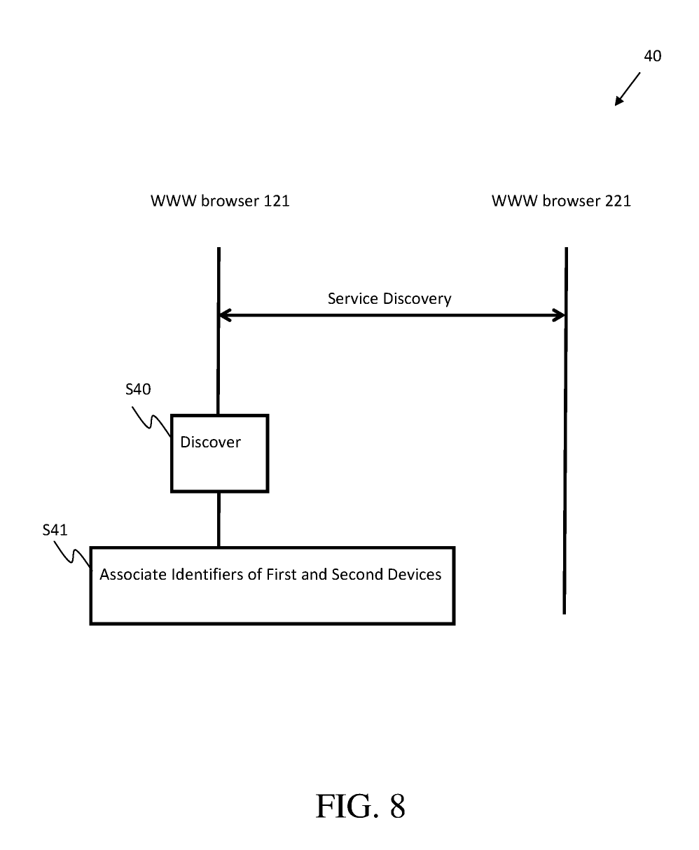

In some embodiments, the DB 122 may be generated according to a method 40 as depicted in FIG. 8. In the embodiments, the first and second computing devices 100 and 200 are capable of automatically sending and receiving their respective identifiers (e.g., IP addresses) between each other for automatic service discovery within the range of a wireless communication such as WLAN through the communication circuitry 103 and 203 respectively. Such automatic service discovery may be achieved by way of, for example, a protocol such as a Web Service Dynamic Discovery (WSD) approved by Organization for the Advancement of Structured Information Standards (OASIS), Domain Name System (DNS)-based Service Discovery (DNS-SD) such as multicast DNS (mDNS) published as RFC 6762, Simple Service Discovery Protocol (SSDP) used in Universal Plug And Play (UPnP), Service Discovery Protocol (SDP) used in Bluetooth, and the likes. For the automatic service discovery, each of the WWW browsers 121 and 221 is configured, namely, includes computer program instructions for performing the automatic service discovery using the above protocol. Referring back to FIG. 8, the method 40 may include the WWW browser 121 discovering the presence of the second computing device 200 and obtaining the identifier (e.g., IP address) of the second computing device 200 over the wireless communication (S40); and the WWW browser 121 associating the obtained identifier of the second computing device 200 with the identifier (e.g., IP address) of the first computing device 100 (S41). As a result of the association at the step S41, the DB 122 may be generated. For performance of the method 40, the WWW browser 121 is configured, namely, includes computer program instructions for performing the service discovery and steps S40 through S41.

<DB222>

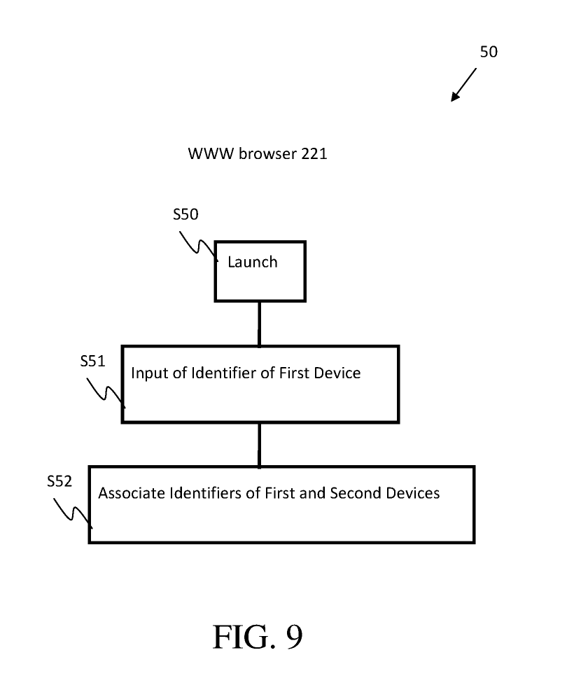

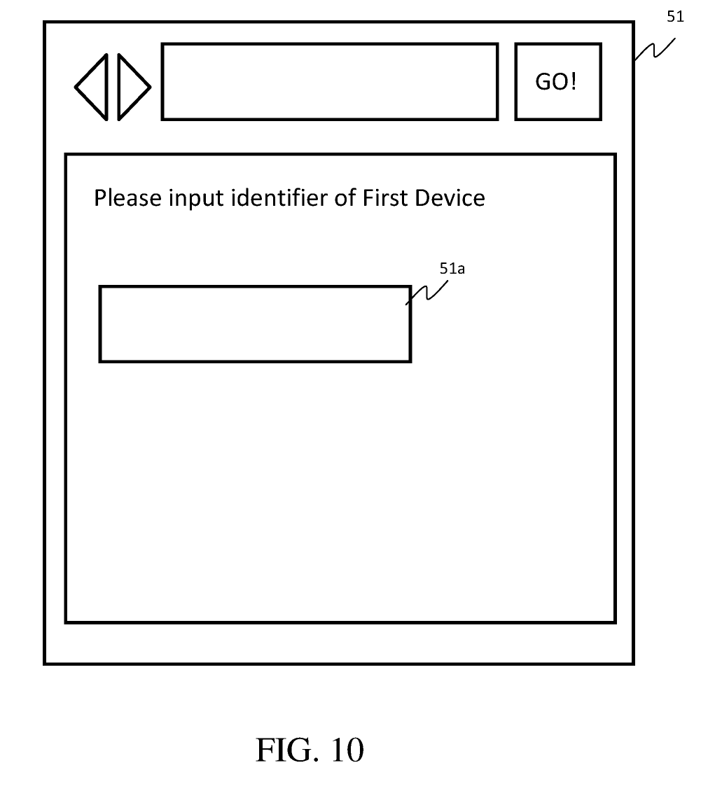

In some embodiments, the DB 222 may be generated according to a method 50 as depicted in FIG. 9. Referring to FIG. 9, the method 50 may include launching the WWW browser 221 by the second computing device 200 in response to a user input through the input unit 207 (S50); the WWW browser 221 displaying, on the display 206, a graphical user interface (GUI) 51 through which to receive a user manual input of the identifier (e.g., IP address) of the first computing device 100 (S51). The GUI 51 may include an input field 51a prompting the user to input the identifier, as depicted in FIG. 10. The method 50 may include, in response to input of the identifier of the first computing device 100, the WWW browser 221 associating the inputted identifier with the identifier (e.g. IP address) of the second computing device 200 (S52). As a result of the association at s S52, the DB 222 may be generated.

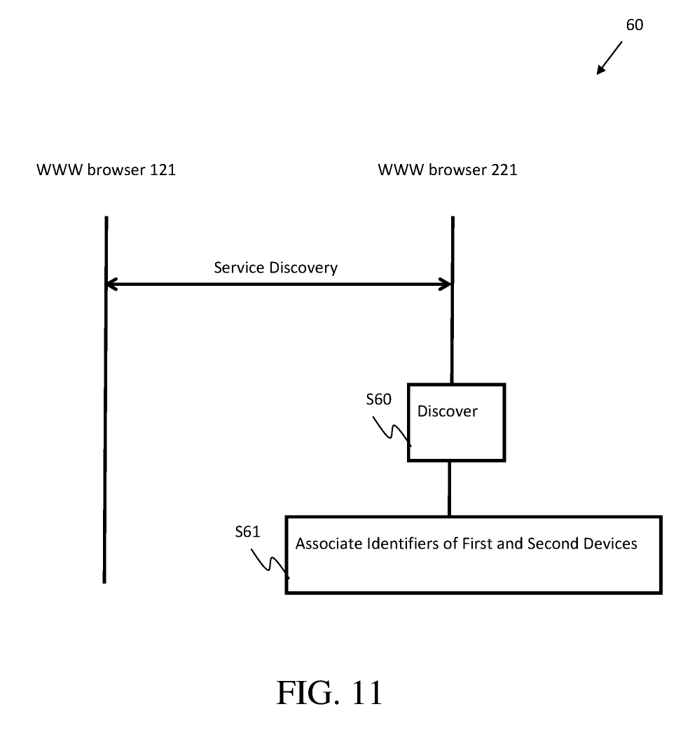

In some embodiments, the DB 222 may be generated according to a method 60 as depicted in FIG. 11. In the embodiments, the first and second computing devices 100 and 200 are capable of automatically sending and receiving their respective identifiers (e.g., IP addresses) between each other for automatic service discovery within the range of a wireless communication such as WLAN through the communication circuitry 103 and 203 respectively. Such automatic service discovery may be achieved by way of, for example, a protocol such as a Web Service Dynamic Discovery (WSD) approved by Organization for the Advancement of Structured Information Standards (OASIS), Domain Name System (DNS)-based Service Discovery (DNS-SD) such as multicast DNS (mDNS) published as RFC 6762, Simple Service Discovery Protocol (SSDP) used in Universal Plug And Play (UPnP), Service Discovery Protocol (SDP) used in Bluetooth, and the likes. For the automatic service discovery, each of the WWW browsers 121 and 221 is configured for, namely, includes computer program instructions for performing the automatic service discovery using the above protocol. Referring back to FIG. 11, the method 60 may include the WWW browser 221 discovering the presence of the first computing device 100 and obtaining the identifier (e.g., IP address) of the first computing device 100 over the wireless communication (S60); and the WWW browser 221 associating the obtained identifier of the first computing device 100 with the identifier (e.g., IP address) of the second computing device 200 (S61). As a result of the association at the step S61, the DB 222 may be generated.

For performance of the method 60, the WWW browser 221 is configured, namely, includes computer program instructions for performing the service discovery and the steps S60 through S61.

### <DB322>

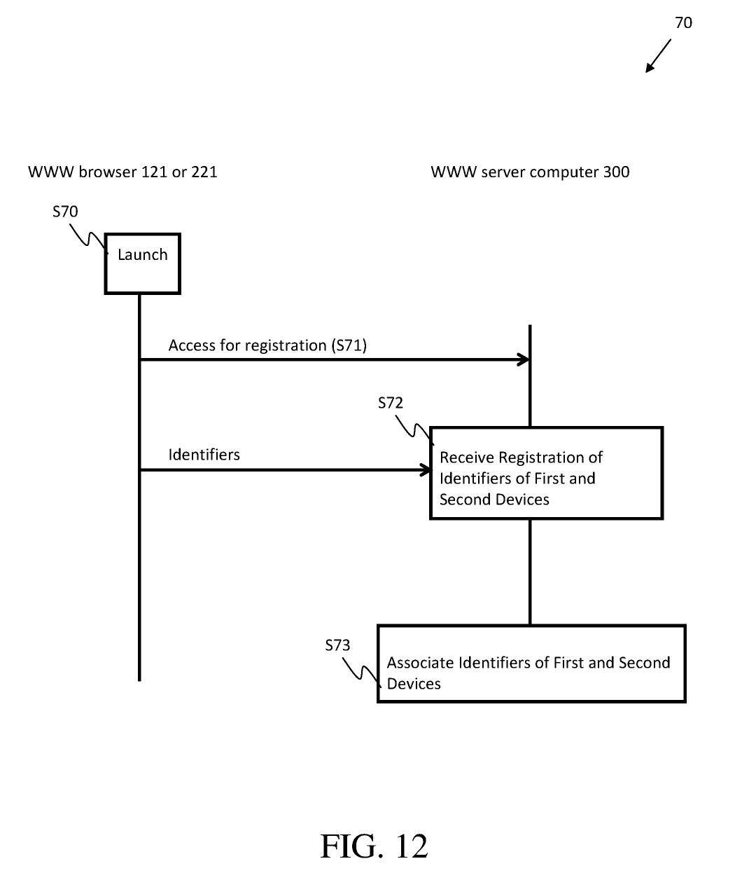

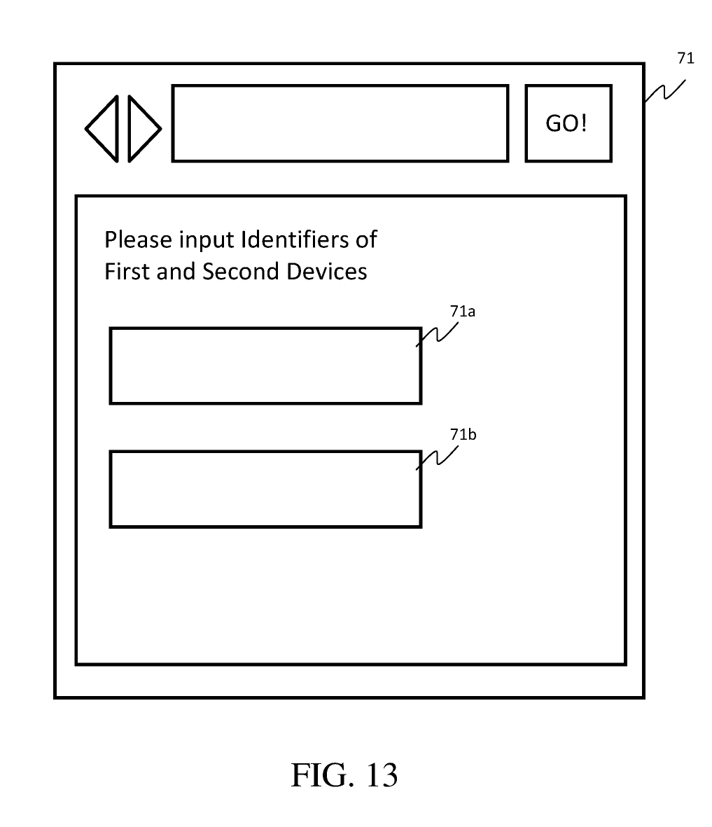

In some embodiments, the DB 322 may be generated according to a method 70 as depicted in FIG. 12. Referring to FIG. 12, the method 70 may include launching the WWW browser 121 or 221 by the first computing device 100 or second computing device 200 in response to a user input through the input unit 101 or 207 (S70); the WWW browser 121 or 221 accessing to the WWW server computer 300 for registration of the computer devices 100 and 200 over the network 10 (S71); the WWW server computer 300 receiving registration of the identifiers (e.g., IP addresses) of the first and second computing devices 100 and 200 over the network 10 (S72); and in response to the reception of registration of the respective identifiers (e.g., IP addresses) of the first and second computing devices 100 and 200, the WWW server computer 300 associating the identifiers of the first and second computing devices 100 and 200 with each other (S73). The registration may be achieved by way of a web page dedicated for the registration sent over the network 10 by the WWW server computer 300 in response to the access to the server computer 300 from the WWW browser 121 or 221, as depicted in FIG. 13. The web page may provide a GUI 71 including input fields 71a and 71b, as depicted in FIG. 13, prompting the user to input the identifiers (e.g., IP addresses) of the first and second computing devices 100 and 200. Or, the registration may be achieved by the browser 121 or 221 sending the DB 122 or 222 to the WWW server computer 300 over the network 10 so as for the WWW server computer 300 to perform the registration with reference to the received DB 122 or 222. As a result of the association at S73, the DB 322 may be generated. For performance of the method 70, the WWW server program 321 is configured, namely, includes computer program instructions for performing the steps S72 through S73.

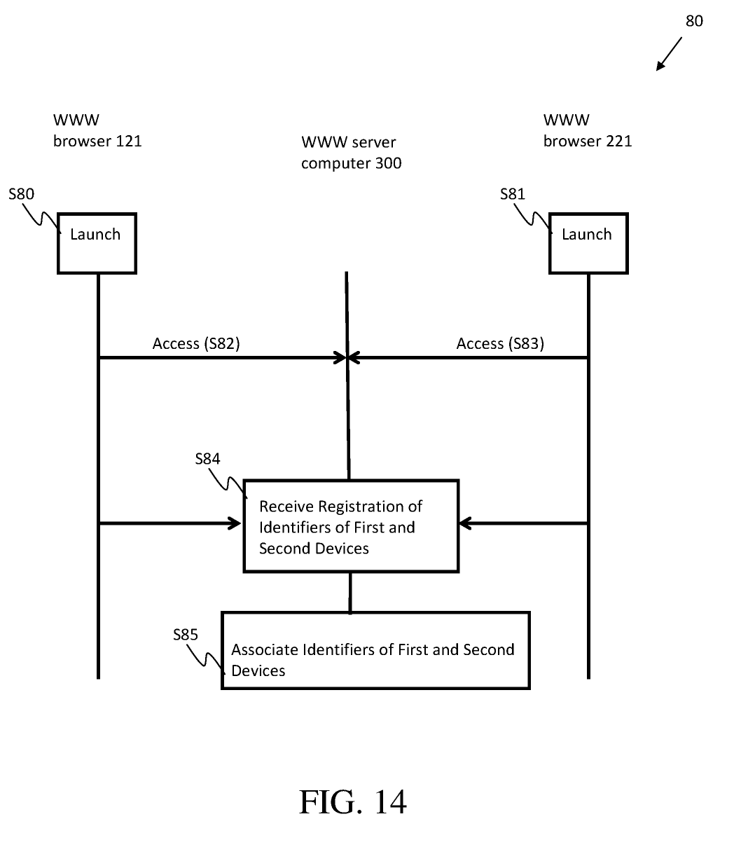

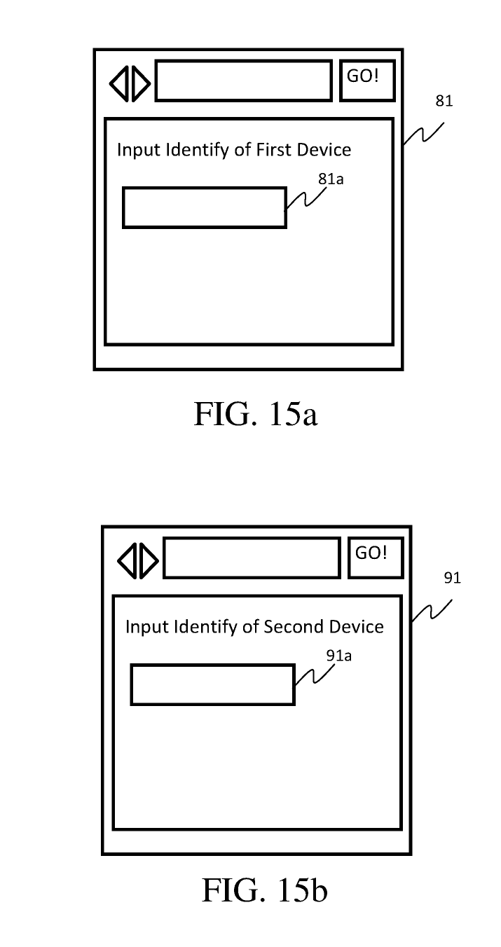

In some embodiments, the DB 322 may be generated according to a method 80 as depicted in FIG. 14. Referring to FIG. 14, the method 80 may include launching both of the WWW browsers 121 and 221 by the first and second computing devices 100 and 200 (S80, S81); both of the WWW browsers 121 and 221 accessing to the WWW server computer 300 for each of the WWW browsers 121 and 221 to register its identity over the network 10 (S82, S83); the WWW server computer 300 receiving registration of the identifier (e.g., IP address) of the first computing device 100 from the WWW browser 121 and the identifier of the second computing device 200 from the WWW browser 221 over the network 10 (S84); in response to the reception of registration of the identifiers (e.g., IP addresses) of the first and second computing devices 100 and 200, the WWW server computer 300 associating the identifiers of the first and second computing devices 100 and 200 with each other (S85). The registration may be achieved by way of web pages dedicated for the registration sent over the network 10 by the WWW server computer 300 in response to the access to the server computer 300 from the WWW browsers 121 and 221, as depicted in FIGS. 15a and 15b where FIG. 15a depicts a first web page sent to the WWW browser 121 whereas FIG. 15b depicts a second web page sent to the WWW browser 221. The first and second web pages may provide GUIs 81 and 91 respectively including input fields 81a or 91a respectively, as depicted in FIGS. 15a and 15b, prompting the user to input the identifiers (e.g., IP addresses) of the first and second computing devices 100 and 200 respectively. Or, the registration may be achieved by the browsers 121 and 221 sending the identifiers (e.g., IP addresses) of the first and second computing devices 100 and 200 to the WWW server computer 300 over the network 10 respectively so as for the WWW server computer 300 to perform the registration of the received identifiers. As a result of the association at S83, the DB 322 may be generated. For performance of the method 80, the WWW browser 121 and WWW browser 221 are configured, namely, include computer program instructions for performing the steps S82 and S83, respectively, while the WWW server program 321 is configured, namely, includes computer program instructions for performing the steps S84 through S85.

### INCORPORATION BY REFERENCE

The above-mentioned techniques for the service discovery process, for example, through the above-mentioned WSD, DNS-SD, SSDP, SDP, etc. are known to those skilled in the art and disclosed, for example, in the following U.S. patent publications, the contents of which are incorporated herein by reference in their entireties:
U.S. patent application publication No. 2015/0373505 filed on Jun. 16, 2015
U.S. issued U.S. Pat. No. 8,559,350 filed on May 15, 2006
U.S. issued U.S. Pat. No. 9,591,674 filed on May 3, 2013
U.S. issued U.S. Pat. No. 8,635,341 filed on Feb. 14, 2008
U.S. patent application publication No. 2014/0214958 filed on Jan. 16, 2014
U.S. issued U.S. Pat. No. 9,326,301 filed on Mar. 6, 2014
U.S. patent application publication No. 2014/0366105 filed on May 28, 2014
U.S. issued U.S. Pat. No. 8,665,744 filed on May 18, 2014
U.S. patent application No. 2016/0219014 filed on Feb. 24, 2014
U.S. issued U.S. Pat. No. 8,625,418 filed on Nov. 24, 2006
U.S. issued U.S. Pat. No. 7,333,464 filed on Feb. 21, 2006

### <Directory Configuration>

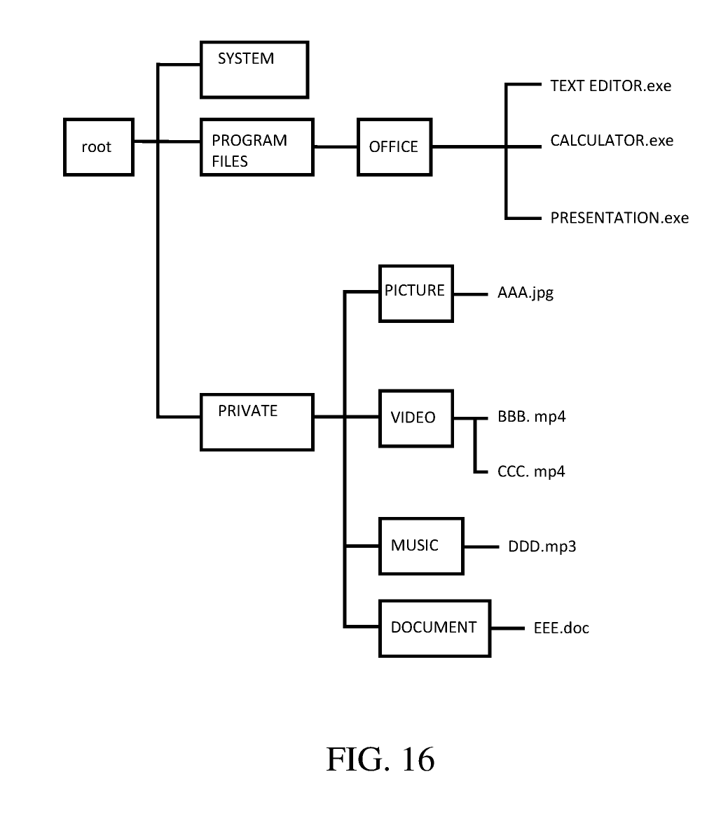

FIG. 16 depicts an exemplary configuration or structure of the directories of the second computing device 200. As illustrated herein, in some embodiments, each of the first and second computing devices 100 and 200 has a hierarchical file system with a top-most directory, for example, labeled “root” and one or more child directories which also server as a parent directory for further one or more child directories. For example, a parent directory labeled “Program Files” under the root directory has a child directory labelled “Office” in which executable computer program files labeled “Text Editor.exe”, “Calculator.exe”, and “Presentation.exe” reside. For example, a parent directory labeled “Private” under the root has child directories labelled “Picture”, “Video”, “Music”, and “Document” in which picture files, video files, music files, and document files can reside. In the first computing device 100, each directory may be a location in the memory 102 onto which the user is allowed to store files, while in the second computing device 200, each directory may be a location in the memory 202 onto which the user is allowed to store files. In the first computing device 100, the file system and the directory configuration may be managed by the OS 120, while in the second computing device 200, the file system and the directory configuration may be managed by the OS 220.

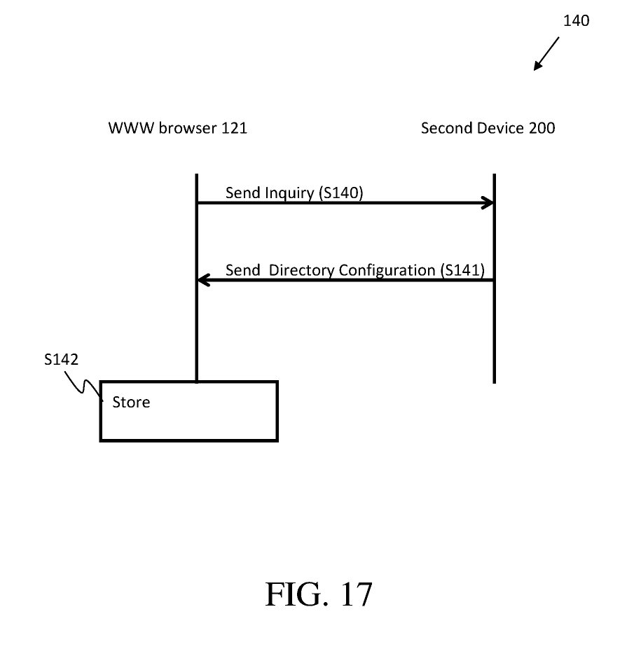

In some embodiments, the directory configuration information 123 may be generated according to a method 140 as depicted in FIG. 17. The method 140 may include the first computing device 100 sending to the second computing device 200 an inquiry for the configuration of the directories over the network 10, by addressing the inquiry to the second computing device 200 with reference to the DB 122 (S140); the second computing device 200 sending back to the first computing device 100 information indicative of the configuration of the directories of the second computing device 200 in response to the inquiry over the network 10 so that the first computing device 100 receives the information (S141); and the first computing device 100 storing the received information as the directory configuration information 123 on the memory 102 (S142). The steps S140 through S142 may be performed by the processors 102 and 202 according to the computer program instructions of the WWW browsers 121 and 221, or the OSes 120 and 220. For performance of the method 140, the WWW browser 121 is configured, namely, includes computer program instructions for performing the steps S140 through S142 while the WWW browser 221 is configured, namely, includes computer program instructions for performing the step141.

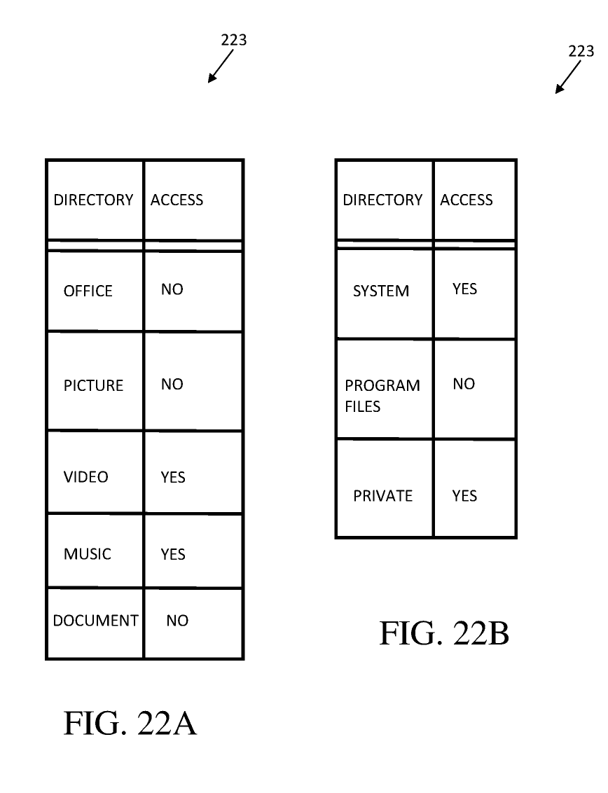

In some embodiments, the second device 200 manages permission to access by the WWW browser 121 for every directory, and notifies the first computing device 100 of one or more permitted directories only. In the embodiments, the second computing device 200 stores a DB 223 associating every directory in the second computing device 200 with one of permission and non-permission for access by the WWW browser 121, as depicted in FIGS. 22A and 22B. FIG. 22A depicts an example where the DB 223 associates each second-level directory with permission or non-permission wherein a directory permitted to be accessed by the WWW browser 121 is labeled “yes” while a directory prohibited to be accessed by the WWW browser 121 is labeled “no”. FIG. 22B depicts an example where the DB 223 associates each third-level directory with permission or non-permission wherein a directory permitted to be accessed by the WWW browser 121 is labeled “yes” while a directory prohibited to be accessed by the WWW browser 121 is labeled “no”. In the embodiments, the step S141 of the method 140 may be modified into the second computing device 200 sending back to the first computing device 100 information indicative of the configuration of the permitted one or more directories only with reference to the DB 223, in response to the inquiry at S140.

### <Improved Download Operation>

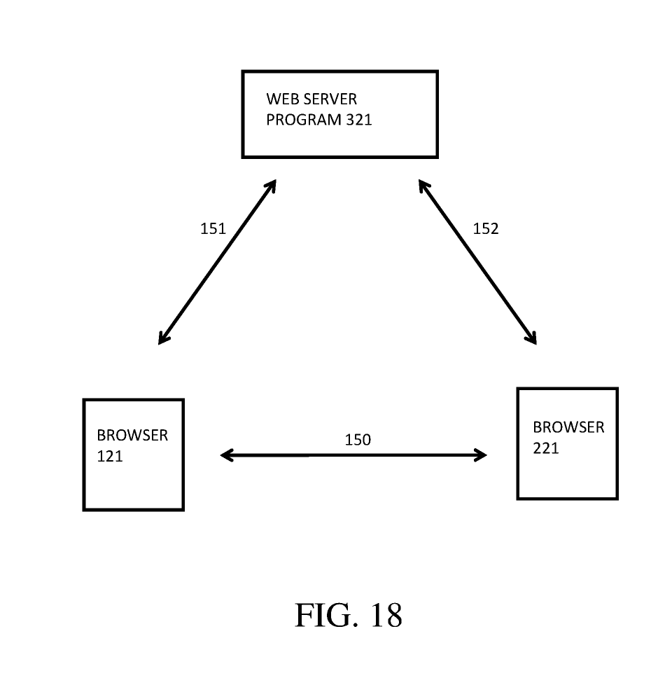

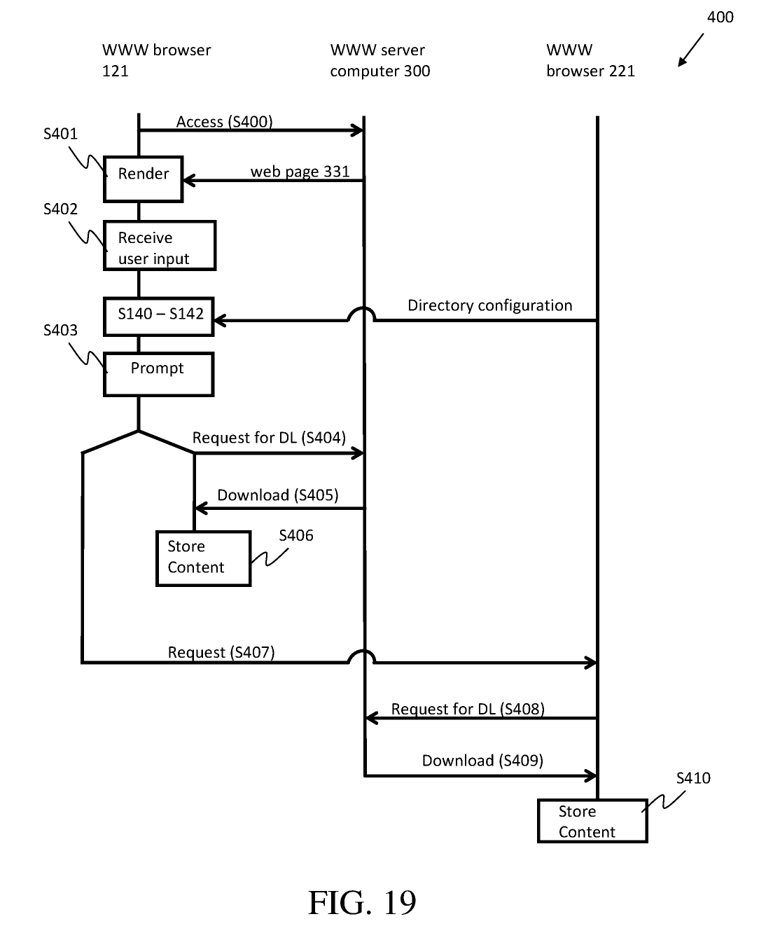

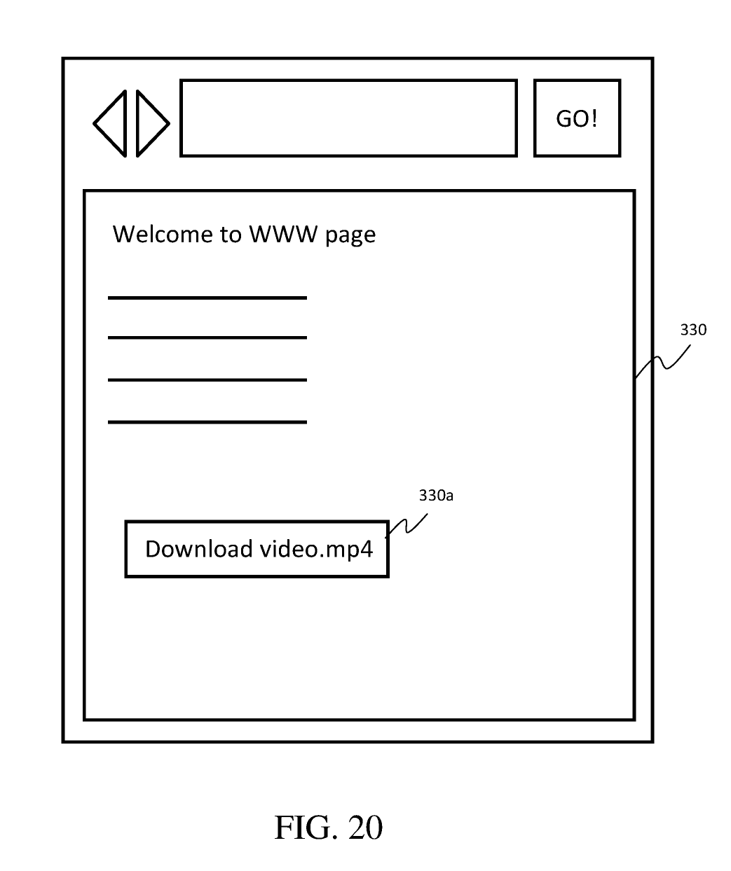

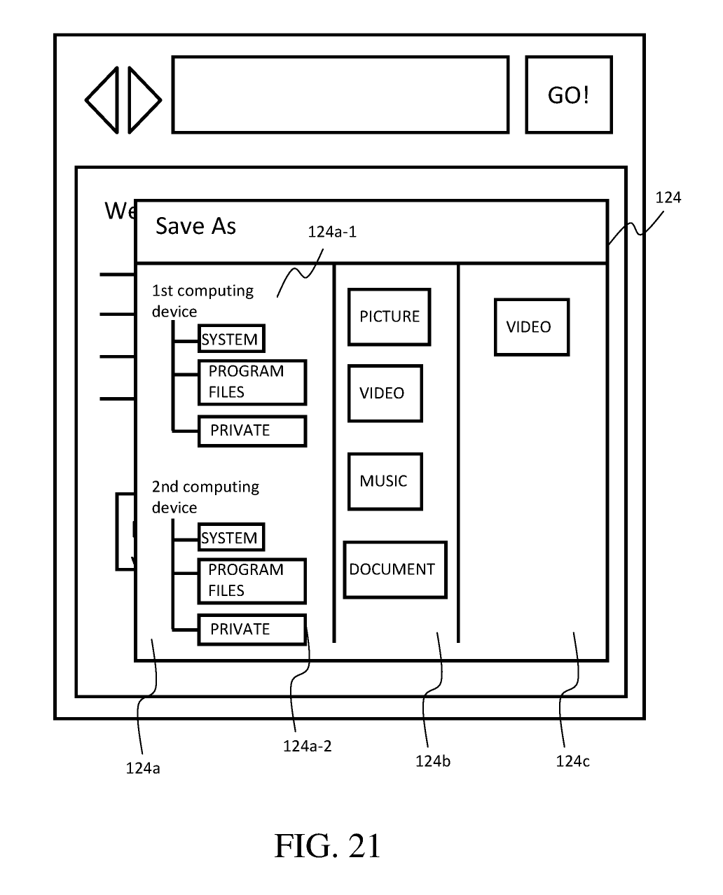

In some embodiments, the WWW browser 121, the browser 221, and the WWW server program 321 operate collaboratively in performing downloading of the content 331 from the WWW server computer 300 over communications 150, 151, and 152 as depicted in FIG. 18, according to a method 400. The communication 150 may be established by the communication circuitry 103 and 203 over the network 10. The communication 151 may be established by the communication circuitry 103 and 303 over the network 10. The communication 152 may be established by the communication circuitry 203 and 303 over the network 10. Referring to FIG. 19, the method 400 may include the WWW browser 121, when executed and in operation, accessing to the WWW server computer 300 for a web page 330 over the communication 151 (S400); the WWW browser 121 receiving, rendering, and displaying, on the display 106, the web page 330 sent over the network 10 by the WWW server computer 300 over the communication 151 (S401); and receiving a user input using the input unit 107 to request download of the content 331 hyperlinked to the web page 330 (S402). The user input for download request may include the user selecting a hyperlink element 330a hyperlinked to the URI of the content 331 by way of the web page 330 as depicted in FIG. 20. The hyperlink element 330a may be a graphical user interface element in any form, such as a text and graphical button, associates with the URI of the content 331. The method 400 may include, in response to the reception of the user input at the step S402, generating the directory configuration information 123 according to the above-mentioned steps S140 through S142. The method 400 may include, with reference to the generated and stored directory configuration information 123, the WWW browser 121 prompting the user to select a desired directory onto which the content 331 is to be downloaded and stored in the second computing device 200 (S403). Specifically, the prompting may include presenting one or more local directories inside the first computing device 100 with reference to the local directory configuration of the first computing device 100 which may be managed by the OS 120 as well as presenting one or more remote directories inside the second computing device 200 with reference to the directory configuration information 123, so as to prompt the user to chose a desired directory out of the local and remote directories. FIG. 21 depicts an example where the WWW browser 121 launches a dialog 124 having: a first area 124a presenting first-level local directories 124a-1 and first-level remote directories 124a-2 to prompt the user to choose one of the first-level directories; a second area 124b presenting second-level directories under a first-level directory chosen in the first area 124a to prompt the user to chose one of the second-level local or remote directories; and a third area 124c presenting a third-level directory under a second-level directory chosen in the second area 124b to prompt the user to finally determine the directory onto which to store the content 331. For example, if the user chooses the “Private” directory of the second computing device 200 in the first area 124a and then chooses the “Video” directory in the second area 124b, this indicates that the “Video” directory in the second computing device 200, as displayed in the third area 124c, is chosen as the destination directory onto which the content 331 is to be stored. The method 400 may include issuing a request for download to the WWW server computer 300 (S404) or another request to the WWW browser 221 (S407) depending on whether a directory in the first computing device 100 or the in the second computing device 200 is selected as the destination directory at the prompting at the step S403. Specifically, the method 400 may include, in response to determination of a directory in the first computing device 100 as the destination directory, the WWW browser 121 issuing a download request to the WWW server computer 300 over the communication 151 for download of the content 331 by specifying the URI of the content 331 (S404); the WWW browser 121 downloading the content 331 from the WWW server computer 300 over the communication 151 when the request is acknowledged by the WWW server computer 300 (S405); and the WWW browser 121 storing the downloaded content 331 on a local directory in the first computing device 100 as selected at the step S403 (S406). The issuance of the download request at the step S404 may include the WWW browser 121 establishing a HTTP session with the WWW server computer 300 for the download, and the download at the step S405 may include downloading over the HTTP session. The method 400 may include, in response to determination of a remote directory in the second computing device 200 as the destination directory, the WWW browser 121 issuing a request to the WWW browser 221 over the communication 150 for requesting the WWW browser 221 to download the content 331, by addressing the request to the second computing device 200 with reference to the DB 122 (S407). The request at the step S407 may include information indicative of the URI of the content 331 and information indicative of the destination directory in the second computing device 200 as determined at the step S403. The method 400 may include, in response to the request at the step S407, the WWW browser 221 issuing a download request to the WWW server computer 300 over the communication 152 for download of the content 331 by specifying the URI of the content 331 (S408); downloading the content 331 from the WWW server computer 300 over the communication 152 when the request at the step S408 is acknowledged by the WWW server computer 300 (S409); and storing the downloaded content 331 on the destination directory in the second computing device 200 as determined at the step S403, namely, as requested at the step S407 (S410). In sum, the request by the WWW browser 121 at the step S407 invokes the request by the WWW browser 221 at the step S408. The issuance of the download request at the step S408 may include the WWW browser 221 establishing a HTTP session with the WWW server computer 300 for the download, and the download at the step S409 may include downloading over the HTTP session. For performance of the method 400, the WWW browser 121 is configured, namely, includes computer program instructions for performing the steps S400 through S407 while the WWW browser 221 is configured, namely, includes computer program instructions for performing the steps S408 through S410.

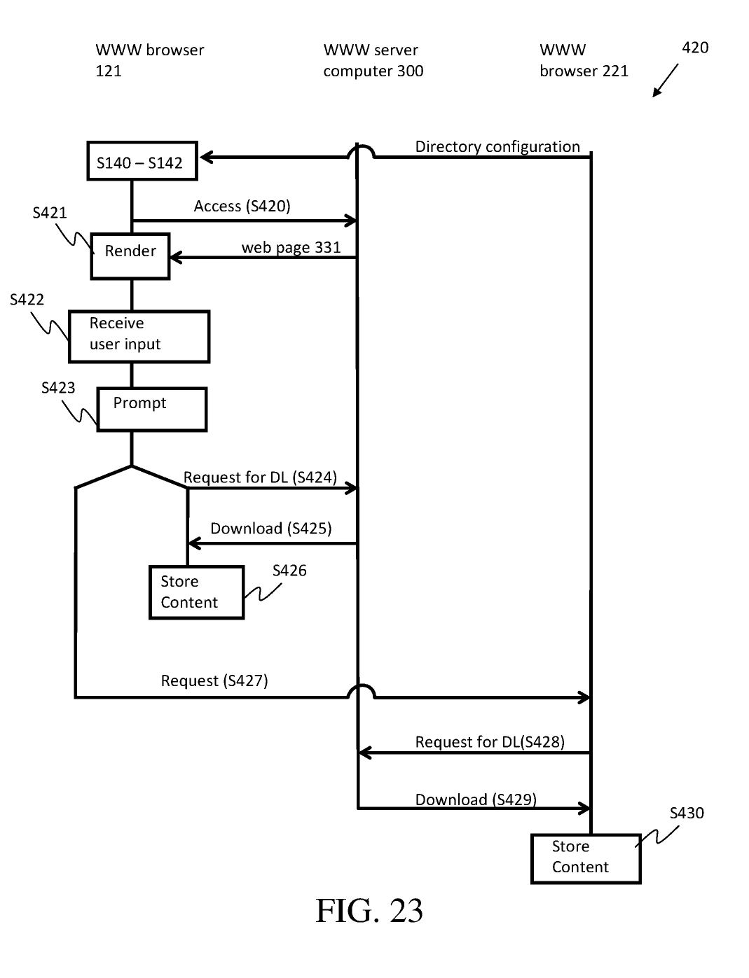

In some embodiments, the WWW browser 121, the WWW browser 221, and the WWW server program 321 operate collaboratively in performing download of the content 331 from the WWW server computer 300 over communications 150, 151, and 152 according to a method 420. Referring to FIG. 23, the method 420 may include generating the directory configuration information 123 according to the above-mentioned steps S140 through S142 automatically when the WWW browsers 121 and 222 are launched and in operation. The generation of the directory configuration information 123 herein may include performing the steps S140 through S142 once upon launch of the WWW browsers 121 and 221; performing the steps S140 through S142 a predetermined times during the WWW browsers 121 and 221 being in operation; or performing the steps S140 through S142 periodically or intermittently to update the directory configuration information 123. The method 420 may include the WWW browser 121, when executed and in operation, accessing to the WWW server computer 300 for a web page 330 over the communication 151 (S420); the WWW browser 121 receiving, rendering, and displaying, on the display 106, the web page 330 sent over the network 10 by the WWW server computer 300 over the communication 151 (S421); and receiving a user input using the input unit 107 to request download of the content 331 hyperlinked to the web page 330 (S422). The user input for download request may include the user selecting a hyperlink element 330a hyperlinked to the URI of the content 331 by way of the web page 330 as depicted in FIG. 20. The hyperlink element 330a may be a graphical user interface element in any form, such as a text and graphical button, associates with the URI of the content 331. The method 420 may include, in response to the reception of the user input at the step S422, with reference to the generated and stored directory configuration information 123, the WWW browser 121 prompting the user to select a desired directory onto which the content 331 is to be downloaded and stored in the second computing device 200 (S423). Specifically, the prompting may include presenting one or more local directories inside the first computing device 100 with reference to the local directory configuration of the first computing device 100 which may be managed by the OS 120 as well as presenting one or more remote directories inside the second computing device 200 with reference to the directory configuration information 123, so as to prompt the user to chose a desired directory out of the local and remote directories. FIG. 21 depicts an example where the WWW browser 121 launches a dialog 124 having: a first area 124a presenting first-level local directories 124a-1 and first-level remote directories 124a-2 to prompt the user to choose one of the first-level directories; a second area 124b presenting second-level directories under a first-level directory chosen in the first area 124a to prompt the user to chose one of the second-level local or remote directories; and a third area 124c presenting a third-level directory under a second-level directory chosen in the second area 124b to prompt the user to finally determine the directory onto which to store the content 331. For example, if the user chooses the “Private” directory of the second computing device 200 in the first area 124a and then chooses the “Video” directory in the second area 124b, this indicates that the “Video” directory in the second computing device 200, as displayed in the third area 124c, is chosen as the destination directory onto which the content 331 is to be stored. The method 420 may include issuing a request for download to the WWW server computer 300 (S424) or another request to the WWW browser 221 (S427) depending on whether a directory in the first computing device 100 or in the second computing device 200 is selected as the destination directory at the prompting at S423. Specifically, the method 420 may include, in response to determination of a directory in the first computing device 100 as the destination directory, the WWW browser 121 issuing a download request to the WWW server computer 300 over the communication 151 for download of the content 331 by specifying the URI of the content 331 (S424); the WWW browser 121 downloading the content 331 from the WWW server computer 300 over the communication 151 when the request is acknowledged by the WWW server computer 300 (S425); and the WWW browser 121 storing the downloaded content 331 on a local directory in the first computing device 100 as selected at S423 (S426). The issuance of the download request at the step S424 may include the WWW browser 121 establishing a HTTP session with the WWW server computer 300 for the download, and the download at the step S425 may include downloading over the HTTP session. The method 420 may include, in response to determination of a remote directory in the second computing device 200 as the destination directory, the WWW browser 121 issuing a request to the WWW browser 221 over the communication 150 for requesting the WWW browser 221 to download the content 331, by addressing the request to the second computing device 200 with reference to the DB 122 (S427). The request at S427 may include information indicative of the URI of the content 331 and information indicative of the destination directory in the second computing device 200 as determined at the step S423. The method 420 may include, in response to the request at S427, the WWW browser 221 issuing a download request to the WWW server computer 300 over the communication 152 for download of the content 331 by specifying the URI of the content 331 (S428); downloading the content 331 from the WWW server computer 300 over the communication 152 when the request at S428 is acknowledged by the WWW server computer 300 (S429); and storing the downloaded content 331 on the destination directory in the second computing device 200 as determined at S423, namely, as requested at S427 (S430). In sum, the request by the WWW browser 121 at the step S427 invokes the request by the WWW browser 221 at the step S428. The issuance of the download request at the step S428 may include the WWW browser 221 establishing a HTTP session with the WWW server computer 300 for the download, and the download at the step S429 may include downloading over the HTTP session. For the download operation according to the steps S420 through S430, the WWW browser 121 is configured, namely, includes computer program instructions for performing the steps S420 through S427 while the WWW browser 221 is configured, namely, includes computer program instructions for performing the steps S428 through S430.

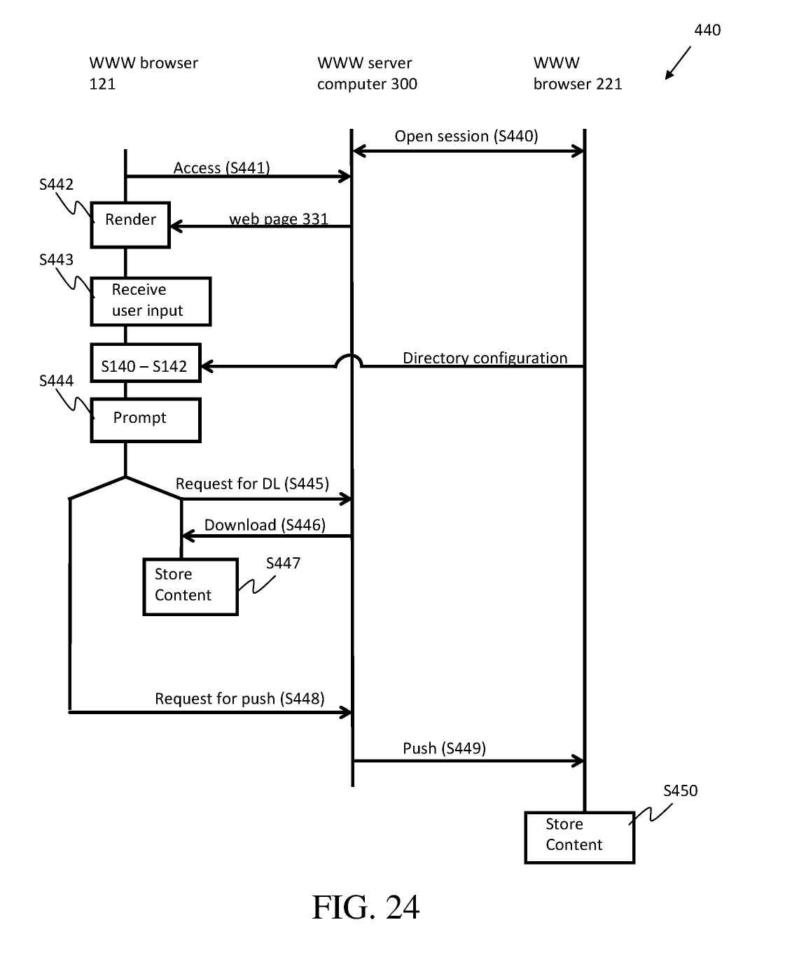

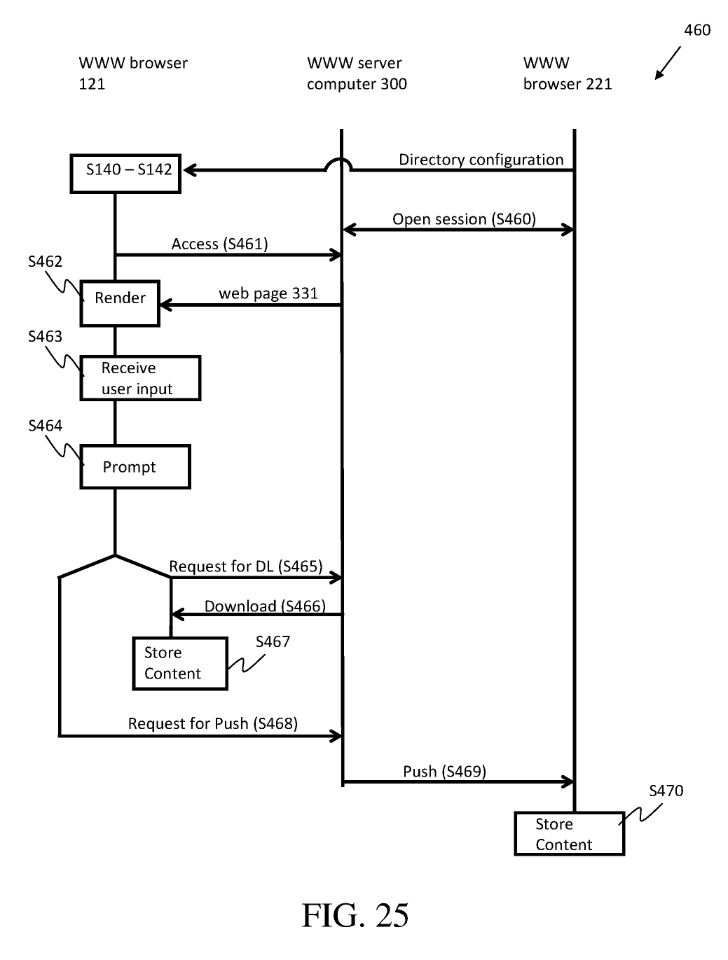

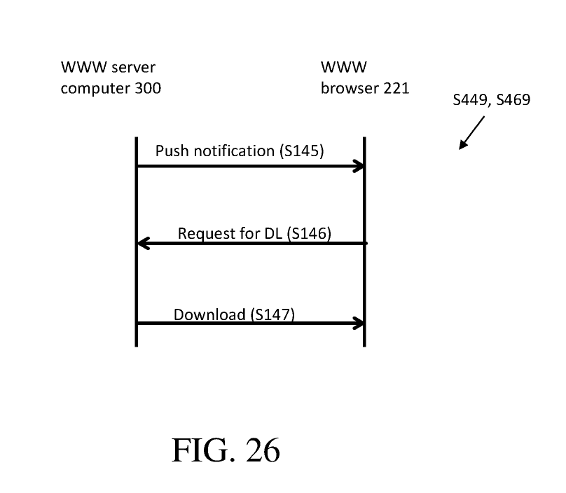

In some embodiments, the WWW browser 121, the WWW browser 221, and the WWW server program 321 operate collaboratively in performing downloading of the content 331 from the WWW server computer 300 over communications 150, 151, and 152 as depicted in FIG. 24, according to a method 440. Referring to FIG. 24, the method 440 may include the WWW browser 221 establishing a session, such as a HTTP session, with the WWW server computer 300 over the communication 152 to keep the session open or active in order to receive an after-mentioned “push” from the server computer 300 over the session (S440); the WWW browser 121, when executed and in operation, accessing to the WWW server computer 300 for a web page 330 over the communication 151 (S441); the WWW browser 121 receiving, rendering, and displaying, on the display 106, the web page 330 sent over the network 10 by the WWW server computer 300 over the communication 151 (S442); and receiving a user input using the input unit 107 to request download of the content 331 hyperlinked to the web page 330 (S443). The user input for download request may include the user selecting a hyperlink element 330a hyperlinked to the URI of the content 331 by way of the web page 330 as depicted in FIG. 20. The hyperlink element 330a may be a graphical user interface element in any form, such as a text and graphical button, associates with the URI of the content 331. The method 440 may include, in response to the reception of the user input at the step S443, generating the directory configuration information 123 according to the above-mentioned steps S140 through S142. The method 440 may include, with reference to the generated and stored directory configuration information 123, the WWW browser 121 prompting the user to select a desired directory onto which the content 331 is to be downloaded and stored in the second computing device 200 (S444). Specifically, the prompting may include presenting one or more local directories inside the first computing device 100 with reference to the local directory configuration of the first computing device 100 which may be managed by the OS 120 as well as presenting one or more remote directories inside the second computing device 200 with reference to the directory configuration information 123, so as to prompt the user to chose a desired directory out of the local and remote directories. FIG. 21 depicts an example where the WWW browser 121 launches a dialog 124 having: a first area 124a presenting first-level local directories 124a-1 and first-level remote directories 124a-2 to prompt the user to choose one of the first-level directories; a second area 124b presenting second-level directories under a first-level directory chosen in the first area 124a to prompt the user to chose one of the second-level local or remote directories; and a third area 124c presenting a third-level directory under a second-level directory chosen in the second area 124b to prompt the user to finally determine the directory onto which to store the content 331. For example, if the user chooses the “Private” directory of the second computing device 200 in the first area 124a and then chooses the “Video” directory in the second area 124b, this indicates that the “Video” directory in the second computing device 200, as displayed in the third area 124c, is chosen as the destination directory onto which the content 331 is to be stored. The method 440 may include issuing a request for download to the WWW server computer 300 (S445) or a request for “push” to the WWW server computer 300 (S448) depending on whether a directory in the first computing device 100 or the in the second computing device 200 is selected as the destination directory at the prompting at the step S444. Specifically, the method 440 may include, in response to determination of a directory in the first computing device 100 as the destination directory, the WWW browser 121 issuing the download request to the WWW server computer 300 over the communication 151 for download of the content 331 to the WWW browser 121 by specifying the URI of the content 331 (S445); the WWW browser 121 downloading the content 331 from the WWW server computer 300 over the communication 151 when the request is acknowledged by the WWW server computer 300 (S446); and the WWW browser 121 storing the downloaded content 331 on a local directory in the first computing device 100 as selected at the step S444 (S447). The issuance of the request for download at the step S445 may include establishing a HTTP session with the WWW server computer 300 for the download, and the download at the step S446 may include downloading over the HTTP session. The method 440 may include, in response to determination of a remote directory in the second computing device 200 as the destination directory, the WWW browser 121 issuing a request to the WWW server computer 300 over the communication 151 for transfer of the content 331 to the WWW browser 221 in a pushing manner, by specifying the URI of the content 331 (S448). In sum, the request by the WWW browser 121 at the step S448 invokes the push by the WWW server program 321 at the step S449. The “push” or transfer in a pushing manner herein may be defined as the WWW server computer 300 initiating transfer of a content to the WWW browser 221 so as for the WWW browser 221 to download the content, without an original request to do so by the WWW browser 221. The request at the step 448 may include the URI of the content 331, the identifier (e.g., IP address) of the second computing device 200 in the DB 122, and information indicative of the destination directory in the second computing device 200 as determined at the step S444. The method 440 may include the WWW server program 321, in response to the request at the step S448, with reference to the identifier (e.g., IP address) of the second computing device 200 contained in the DB 322 or in the request at the step 448, transferring the content 331 in a pushing manner to the WWW browser 221 over the communication 152 (S449); the WWW browser 221 downloading the content 332 based on the push (S449); and the WWW browser 221 storing the pushed content 331 on the destination directory in the second computing device 200 (S450). An example of the push transfer at the step S449 may include addressing a message, such as a HTTP response, to the identifier of the second computing device 200 over the session being kept open since the step S440, so that the WWW browser 221 receives the message over the session. In the example, the message may include the content 331 and information indicative of the destination directory in the second computing device 200 as selected at the step S444, so that the WWW browser 221 downloads and stores the content 331 on the destination directory with reference to the message. Another example of the push transfer at the step S449 may include, as depicted in FIG. 26, firstly the WWW server program 321 sending a push notification containing the URI of the content 331 and the information indicative of the destination directory in the second computing device 200 as selected at the step S444, to the WWW browser 221 over the communication 152, namely, over the session being kept open since the step S440 (S145); the WWW browser 221, in response to the push notification, with reference to the URI of the content 331, sending a request to the WWW server computer 300 over the communication 152, namely, over the open session, for download of the content 331 (S146); and the WWW browser 221 downloading the content 331 over the communication 152, namely, over the open session, when the request at the step S146 is acknowledged by the WWW server computer 300 (S147). In the example, the storing of the content 331 at the step S450 may include storing the content 331 on the destination directory with reference to the information contained in the push notification at the step S145. Such push transfer in the embodiments may be achieved by a known protocol such as HTTP Server Push, Pushlet, and Web Push Protocol. For performance of the method 440, the WWW browser 121 is configured, namely, includes computer program instructions for performing the steps S441 through S448 while the WWW browser 221 is configured, namely, includes computer program instructions for performing the steps S440, S449, and S450. The WWW server program 321 is configured, namely, includes computer program instructions for performing the steps S440 and S449.

In some embodiments, the WWW browser 121, the WWW browser 221, and the WWW server program 321 operate collaboratively in performing downloading of the content 331 from the WWW server computer 300 over communications 150, 151, and 152 as depicted in FIG. 24, according to a method 460. Referring to FIG. 26, the method 460 may include generating the directory configuration information 123 according to the above-mentioned steps S140 through S142 automatically when the WWW browsers 121 and 222 are launched and in operation. The generation of the directory configuration information 123 herein may include performing the steps S140 through S142 once upon launch of the WWW browsers 121 and 221; performing the steps S140 through S142 a predetermined times during the WWW browsers 121 and 221 being in operation; or performing the steps S140 through S142 periodically or intermittently to update the directory configuration information 123. The method 460 may include the WWW browser 221 establishing a session, such as a HTTP session, with the WWW server computer 300 over the communication 152 to keep the session open or active in order to receive an after-mentioned “push” from the server computer 300 over the session (S460); the WWW browser 121, when executed and in operation, accessing to the WWW server computer 300 for a web page 330 over the communication 151 (S461); the WWW browser 121 receiving, rendering, and displaying, on the display 106, the web page 330 sent over the network 10 by the WWW server computer 300 over the communication 151 (S462); and receiving a user input using the input unit 107 to request download of the content 331 hyperlinked to the web page 330 (S463). The user input for download request may include the user selecting a hyperlink element 330a hyperlinked to the URI of the content 331 by way of the web page 330 as depicted in FIG. 20. The hyperlink element 330a may be a graphical user interface element in any form, such as a text and graphical button, associates with the URI of the content 331. The method 460 may include, in response to the reception of the user input at the step S463, with reference to the generated and stored directory configuration information 123, the WWW browser 121 prompting the user to select a desired directory onto which the content 331 is to be downloaded and stored in the second computing device 200 (S464). Specifically, the prompting may include presenting one or more local directories inside the first computing device 100 with reference to the local directory configuration of the first computing device 100 which may be managed by the OS 120 as well as presenting one or more remote directories inside the second computing device 200 with reference to the directory configuration information 123, so as to prompt the user to chose a desired directory out of the local and remote directories. FIG. 21 depicts an example where the WWW browser 121 launches a dialog 124 having: a first area 124a presenting first-level local directories 124a-1 and first-level remote directories 124a-2 to prompt the user to choose one of the first-level directories; a second area 124b presenting second-level directories under a first-level directory chosen in the first area 124a to prompt the user to chose one of the second-level local or remote directories; and a third area 124c presenting a third-level directory under a second-level directory chosen in the second area 124b to prompt the user to finally determine the directory onto which to store the content 331. For example, if the user chooses the “Private” directory of the second computing device 200 in the first area 124a and then chooses the “Video” directory in the second area 124b, this indicates that the “Video” directory in the second computing device 200, as displayed in the third area 124c, is chosen as the destination directory onto which the content 331 is to be stored. The method 460 may include issuing a request for download to the WWW server computer 300 (S465) or a request for “push” to the WWW server computer 300 (S468) depending on whether a directory in the first computing device 100 or the in the second computing device 200 is selected as the destination directory at the prompting at the step S464. Specifically, the method 460 may include, in response to determination of a directory in the first computing device 100 as the destination directory, the WWW browser 121 issuing the download request to the WWW server computer 300 over the communication 151 for download of the content 331 to the WWW browser 121 by specifying the URI of the content 331 (S465); the WWW browser 121 downloading the content 331 from the WWW server computer 300 over the communication 151 when the request is acknowledged by the WWW server computer 300 (S466); and the WWW browser 121 storing the downloaded content 331 on a local directory in the first computing device 100 as selected at the step S464 (S467). The issuance of the request for download at the step S465 may include establishing a HTTP session with the WWW server computer 300 for the download, and the download at the step S466 may include downloading over the HTTP session. The method 460 may include, in response to determination of a remote directory in the second computing device 200 as the destination directory, the WWW browser 121 issuing a request to the WWW server computer 300 over the communication 151 for transfer of the content 331 to the WWW browser 221 in a pushing manner, by specifying the URI of the content 331 (S468). In sum, the request by the WWW browser 121 at the step S468 invokes the push by the WWW server program 321 at the step S469. The “push” or transfer in a pushing manner herein may be defined as the WWW server computer 300 initiating transfer of a content to the WWW browser 221 so as for the WWW browser 221 to download the content, without an original request to do so by the WWW browser 221. The request at the step 458 may include the URI of the content 331, the identifier (e.g., IP address) of the second computing device 200 in the DB 122, and information indicative of the destination directory in the second computing device 200 as determined at the step S464. The method 460 may include the WWW server program 321, in response to the request at the step S468, with reference to the identifier (e.g., IP address) of the second computing device 200 contained in the DB 322 or in the request at the step 468, transferring the content 331 in a pushing manner to the WWW browser 221 over the communication 152 (S469); the WWW browser 221 downloading the content 331 based on the push (S469); and the WWW browser 221 storing the pushed content 331 on the destination directory in the second computing device 200 (S470). An example of the push transfer at the step S469 may include addressing a message, such as a HTTP response, to the identifier of the second computing device 200 over the session being kept open since the step S460, so that the WWW browser 221 receives the message over the session. In the example, the message may include the content 331 and information indicative of the destination directory in the second computing device 200 as selected at the step S464, so that the WWW browser 221 downloads and stores the content 331 on the destination directory with reference to the message. Another example of the push transfer at the step S469 may include, as depicted in FIG. 26, firstly the WWW server program 321 sending a push notification containing the URI of the content 331 and the information indicative of the destination directory in the second computing device 200 as selected at the step S464, to the WWW browser 221 over the communication 152, namely, over the session being kept open since the step S460 (S145); the WWW browser 221, in response to the push notification, with reference to the URI of the content 331, sending a request to the WWW server computer 300 over the communication 152, namely, over the open session, for download of the content 331 (S146); and the WWW browser 221 downloading the content 331 over the communication 152, namely, over the open session, when the request at the step S146 is acknowledged by the WWW server computer 300 (S147). In the example, the storing of the content 331 at the step S470 may include storing the content 331 on the destination directory with reference to the information contained in the push notification at the step S145. Such push transfer in the embodiments may be achieved by a known protocol such as HTTP Server Push, Pushlet, and Web Push Protocol. For performance of the method 460, the WWW browser 121 is configured, namely, includes computer program instructions for performing the steps S461 through S468 while the WWW browser 221 is configured, namely, includes computer program instructions for performing the steps S460, S469, and S470. The WWW server program 321 is configured, namely, includes computer program instructions for performing the steps S460 and S469.

Thanks to the download operation as described above in accordance with the methods 400, 420, 440, and 460, the WWW browser 221 is able to download the content 331 from the WWW server computer 300 directly on the second computing device 200 based on a user operation for download request made via the WWW browser 121 on the first computing device 100. This may be advantageous especially when the second computing device 200 is a personal computer located in a house of the user while the first computer device 100 is a handheld device such as a smartphone, because the user, carrying the handheld device outside the house and browsing web sites by use of the WWW browser 121, is able to store online contents from the web sites on his/her personal computer at home without transfer of the contents between the handheld device and the personal computer.

### <Improved Webpage Retrieval>

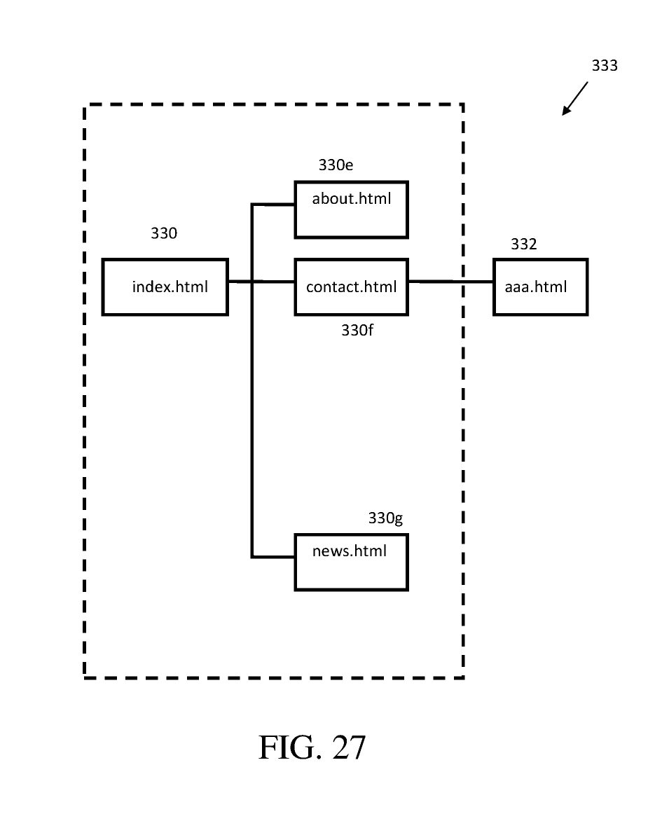

In some embodiments, the WWW browser 121 may comprise improved functionality for fetching or retrieving webpages. FIG. 27 schematically illustrates an example of hyperlink of webpages including the webpage 330. Typically, the webpage 330, with a hyperlink structure as depicted herein, are directly or indirectly hyperlinked with one or more other individual webpages 330e, 330f, 330g, and 332. The webpages 330, and 330e through 330g are pages stored in the same directory on the same server computer, namely, the server computer 300 so that the webpages 330, and 330e through 330g belong to the same top level domain of a URI. As a result, the webpages 330, 330e, 330f, and 330g mutually hyperlinked together compose a single web site 333. Assuming that the top level domain of the URI of the website 333 is “www.server300.com” under which each HTML document corresponding to one of the webpages 330, 330e, 330f, and 330g is stored, the webpages 330, 330e, 330f, and 330g may be identified by “www.server300.com/index.html”, “www.server300.com/about.html”, “www.server300.com/contact.html”, and “www.server300.com/news.html”, respectively, for example. In contrast, the web page 332 is stored on another WWW server computer that is remote and distinctive with a different IP address from the WWW server computer 300 and is accessible over the Internet from the WWW browser 121 and/or 221. For example, the webpage 332 may be identified by “www.otherserver.com/index.html” where the top level domain of the URI of the website 332 is “www.otherserver.com”.

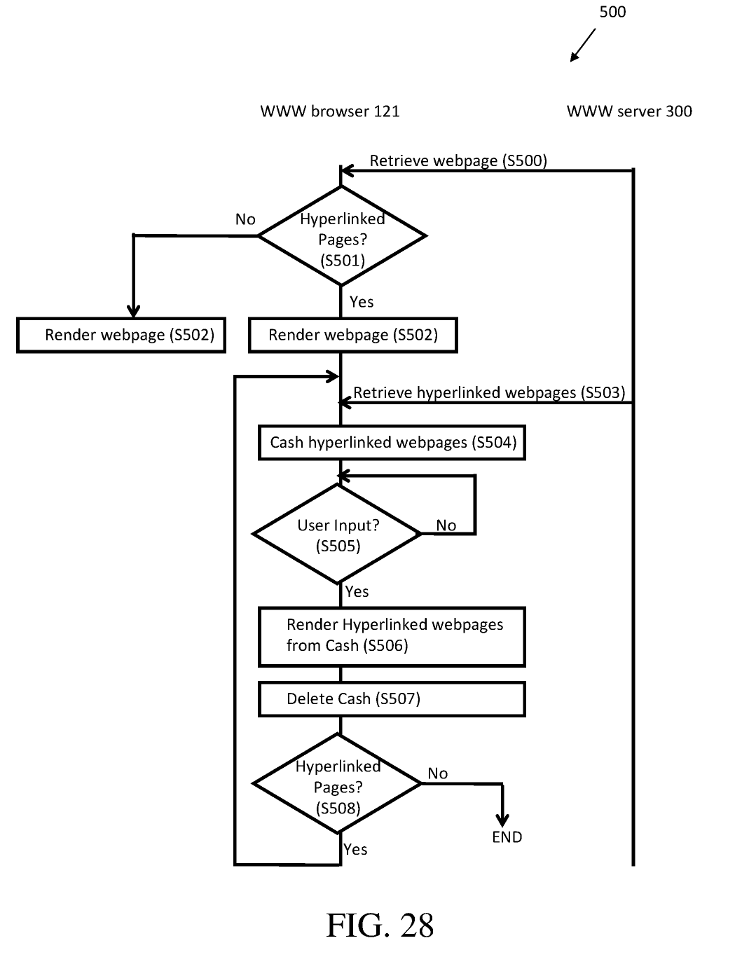

In the embodiments, the WWW browser 121 may perform the improved webpage retrieval according to a method 500 as depicted in FIG. 28. The method 500 includes the WWW browser 121 retrieving a specific webpage (e.g., webpage 330) in response to a user input to specify the URI of the webpage (S500). The retrieval at the step S500 may include the WWW browser 121 issuing a HTTP request for the webpage and receiving a HTML document of the webpage sent by the WWW server computer 300 as a HTTP response in reply to the HTTP request. The method 500 includes the WWW browser 121 determining whether or not the retrieved webpage (i.e., webpage 330) contains one or more other webpages hyperlinked to the retrieved webpage (S501). The determination at the step S501 may include analyzing the HTML document of the retrieved webpage (i.e., webpage 330) to find URIs of the hyperlinked webpages (i.e., webpages 330e, 330f, and 330g). Upon determining that the webpage contains no hyperlinked webpages by failing to find any one of hyperlinked webpages (S501: No), the WWW browser 121 just renders the retrieved webpage (S502). Upon determining that the webpage contains one or more hyperlinked webpages by finding the webpages (S501: Yes), the WWW browser 121 renders the retrieved webpage (i.e., webpage 330) (S502), and in parallel to the rendering, retrieves the hyperlinked webpages (i.e., webpages 330e, 330f, and 330g) found at the step S501 (S503). The retrieval at the step S503 may include the WWW browser 121 issuing a HTTP request for the hyperlinked webpages and receiving HTML documents of the hyperlinked webpages sent by the WWW server computer 300 as a HTTP response in reply to the HTTP request. The WWW browser 121 then cashes the retrieved hyperlinked webpages (S504) until they are read out to be rendered. The cash process at the step S504 may include temporarily storing the HTML documents of the retrieved hyperlinked webpages at a predetermined cash region on the memory 102. The WWW browser 121 keeps rendering the currently rendered webpage (i.e., webpage 330) until a user input is made to select one of the hyperlinked webpage (S505: No). In response to a user input to select one of the hyperlinked webpage through the webpage 330 (S505: Yes), the WWW browser 121 renders the selected webpage (i.e., webpage 330e, 330f, or 330g) by reading out the cashed HTML document of the selected webpage from the memory 102 (S506). At the step S506, the WWW browser 121 may render the selected webpage in place of the originally rendered webpage (i.e., webpage 330). Upon rendering the hyperlinked webpage at the step S506, the WWW browser 121 deletes the remaining webpages which has been cashed according to the step S504, namely, deletes the cashed webpages other than the webpage selected and rendered at the step S506 (S507). In parallel to rendering the selected hyperlinked webpage at the step S506, the WWW browser 121 again determines whether or not the selected webpage (i.e., webpage 330e, 330f, or 330g) contains one or more other webpages hyperlinked to the webpage (S508). The determination at the step S508 may include analyzing the HTML document of the selected webpage (i.e., webpage 330e, 330f, or 330g) to find URIs of the hyperlinked webpages. Upon determining that the selected webpage contains no hyperlinked other webpages by failing to find any one of hyperlinked webpage (S508: No), the WWW browser 121 just keeps rendering the selected webpage. Upon determining that the selected webpage contains one or more hyperlinked webpages by finding the webpages (S508: Yes), the WWW browser 121 again goes back to the step S503 to retrieve the hyperlinked webpages. For performance of the method 500, the WWW browser 121 is configured, namely, includes computer program instructions for performing the steps S500 through S508.

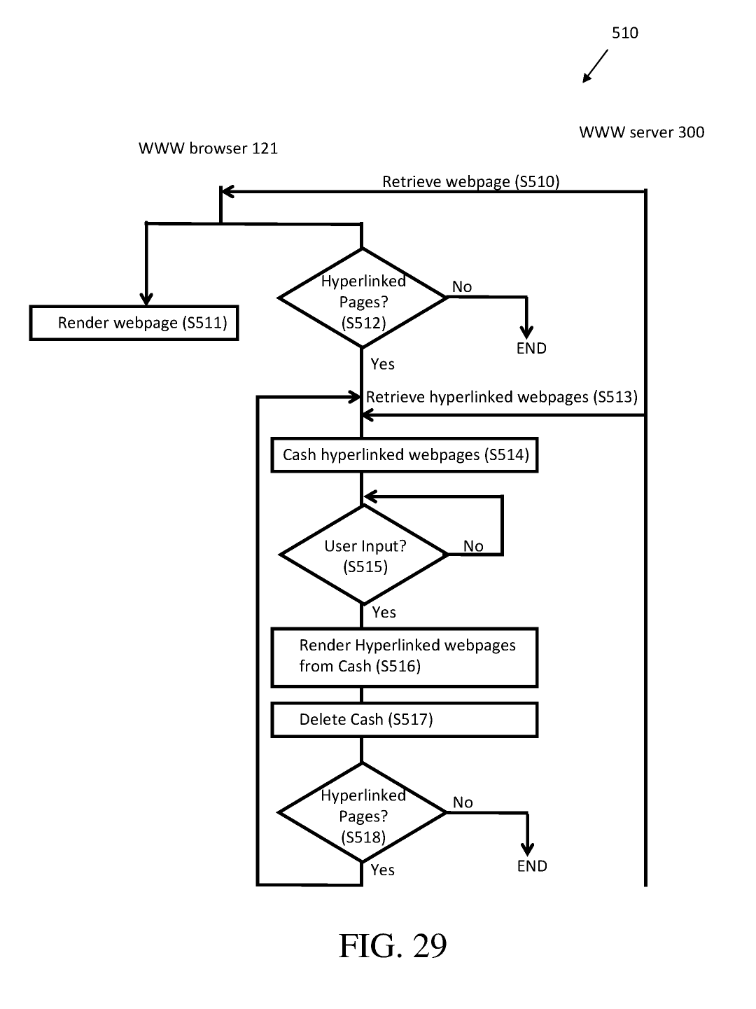

In the embodiments, the WWW browser 121 may perform the improved webpage retrieval according to a method 510 in place of the method 500, as depicted in FIG. 29. The method 510 includes the WWW browser 121 retrieving a specific webpage (e.g., webpage 330) in response to a user input to specify the URI of the webpage (S510). The retrieval at the step S510 may include the WWW browser 121 issuing a HTTP request for the webpage and receiving a HTML document of the webpage sent by the WWW server computer 300 as a HTTP response in reply to the HTTP request. The method 510 includes the WWW browser 121 rendering the retrieved web page (e.g., webpage 330) (S511), and in parallel to the rendering, determining whether or not the retrieved webpage (i.e., webpage 330) contains one or more other webpages hyperlinked to the retrieved webpage (S512). The determination at the step S512 may include analyzing the HTML document of the retrieved webpage (i.e., webpage 330) to find URIs of the hyperlinked webpages (i.e., webpages 330e, 330f, and 330g). Upon determining that the webpage contains no hyperlinked webpages by failing to find any one of hyperlinked webpages (S512: No), the WWW browser 121 does not do anything more than the rendering. Upon determining that the webpage contains one or more hyperlinked webpages by finding the webpages (S512: Yes), the WWW browser 121 retrieves the hyperlinked webpages (i.e., webpages 330e, 330f, and 330g) found at the step S512 (S513). The retrieval at the step S513 may include the WWW browser 121 issuing a HTTP request for the hyperlinked webpages and receiving HTML documents of the hyperlinked webpages sent by the WWW server computer 300 as a HTTP response in reply to the HTTP request. The WWW browser 121 then cashes the retrieved hyperlinked webpages (S514) until they are read out to be rendered. The cash process at the step S514 may include temporarily storing the HTML documents of the retrieved hyperlinked webpages at a predetermined cash region on the memory 102. The WWW browser 121 keeps rendering the currently rendered webpage (i.e., webpage 330) until a user input is made to select one of the hyperlinked webpage (S515: No). In response to a user input to select one of the hyperlinked webpage through the webpage 330 (S515: Yes), the WWW browser 121 renders the selected webpage (i.e., webpage 330e, 330f, or 330g) by reading out the cashed HTML document of the selected webpage from the memory 102 (S516). At the step S506, the WWW browser 121 may render the selected webpage in place of the originally rendered webpage (i.e., webpage 330). Upon rendering the hyperlinked webpage at the step S516, the WWW browser 121 deletes the remaining webpages which has been cashed according to the step S514, namely, deletes the cashed webpages other than the webpage selected and rendered at the step S516 (S517). In parallel to rendering the selected hyperlinked webpage at the step S516, the WWW browser 121 again determines whether or not the selected webpage (i.e., webpage 330e, 330f, or 330g) contains one or more other webpages hyperlinked to the webpage (S518). The determination at the step S518 may include analyzing the HTML document of the selected webpage (i.e., webpage 330e, 330f, or 330g) to find URIs of the hyperlinked webpages. Upon determining that the selected webpage contains no hyperlinked other webpages by failing to find any one of hyperlinked webpage (S518: No), the WWW browser 121 just keeps rendering the selected webpage. Upon determining that the selected webpage contains one or more hyperlinked webpages by finding the webpages (S518: Yes), the WWW browser 121 again goes back to the step S513 to retrieve the hyperlinked webpages. For performance of the method 510, the WWW browser 121 is configured, namely, includes computer program instructions for performing the steps S510 through S518.

In the embodiments, as described above, each of the methods 500 and 510 preliminarily and automatically retrieves and cashes other webpages hyperlinked to a specific webpage in parallel to rendering the specific webpage as long as the specific webpage contains at least one hyperlink to another webpage. The methods 500 and 510 are advantageous in enhancing speedy access to the hyperlinked webpages when a user moves to the hyperlinked webpages in browsing the original webpage. The methods 500 and 510 are also advantageous in a situation where wireless communication is unstable or expected to become unstable, for example, in the situation where the device 100, which is in the form of a portable or mobile device such as a smartphone, is traveling at a high speed with a user who is navigating the WWW browser 121 outdoors.

### <Hover and Tap Detection, and Improved Media Player GUI>

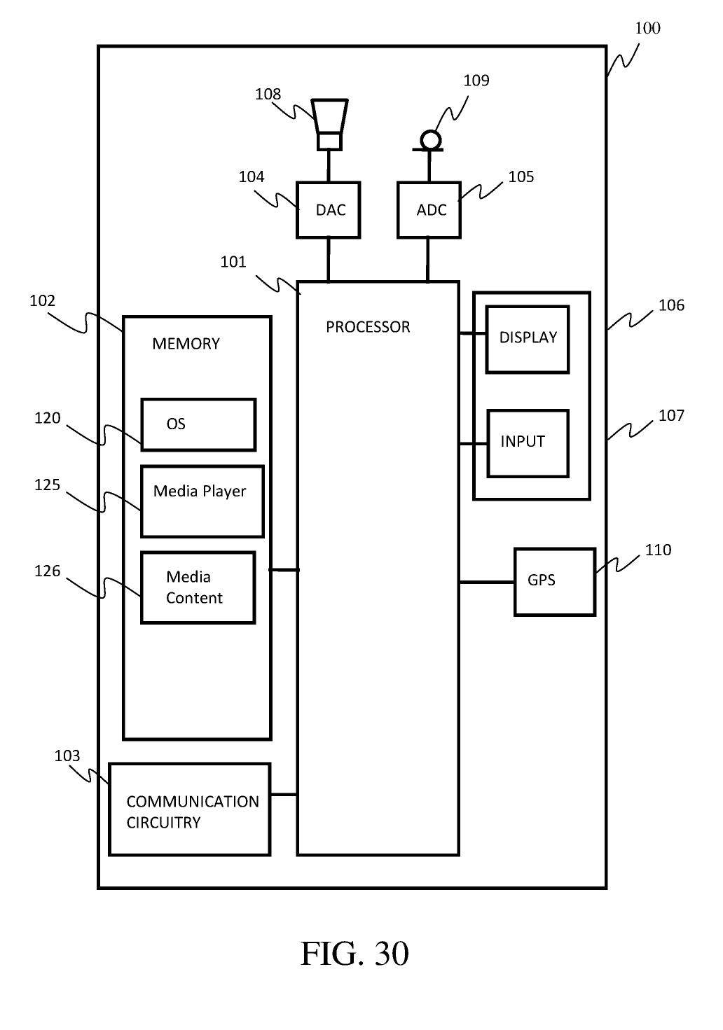

In some embodiments, the first device 100 is configured to distinctively detect (a) hover of a physical object such as a user's finger and a stylus in proximity above a display screen and (b) a tap of the physical object onto the display screen which occurs subsequently to the tap, and configured to control display of graphical user interface elements of a media player in response to detection of the hover and tap. In the embodiments, as depicted in FIG. 30, in the first device 100, the display 106 and the input 107 are mechanically integrated with each other to constitute a sensitive display capable of detecting the tap and hover. An example of the techniques for implementing such sensitive display and how it works may be found and taught in U.S. issued U.S. Pat. No. 9,116,598 filed on Jan. 1, 2014 and issued on Aug. 25, 2015, entitled “User Interface for Use in Computing Device with Sensitive Display”, the content of which is incorporated herein by reference in its entirety. In the embodiments, as depicted in FIG. 30, the computing device 100 includes a media player 125 and one or more media contents 126 on the memory 102. The media player 125 is a computer program resident on the memory 102, including computer instructions for playing back a media content selected by a user out of the media contents 126 and for pausing, fast-forwarding, rewinding, or otherwise controlling playback of the selected media content. An example of the media contents 126 may be a media content downloaded by a user from a remote server computer over the Internet through the communication circuitry 103 to be stored on the memory 102. The media content 126 may be in any form, including a music file such as the one which consists of audio data, and a video clip such as the one which consists of audio and video data. The media content 126 may be encoded by a specific encoding format such as, for example, a video encoding format pursuant to Moving Picture Experts Group (MPEG) 4 standard and an audio encoding format pursuant to Advanced Audio Coding (AAC), in which case the media player 125 includes a decoder to decode in accordance with the specific format for playback of the encoded media content 126.

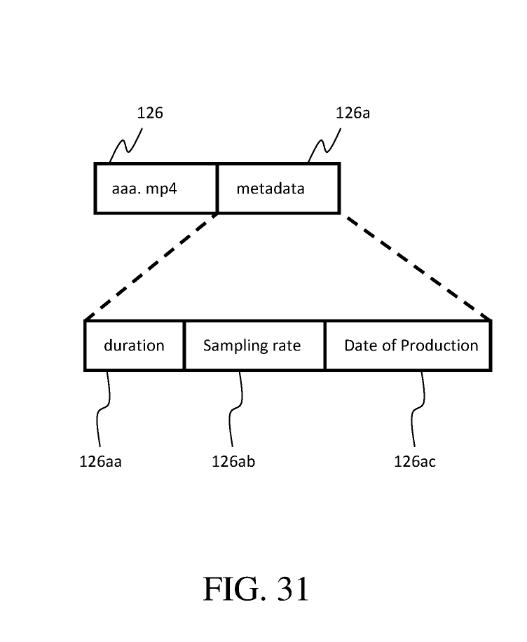

FIG. 31 depicts an example of the media content 126 and metadata 126a associated with the media content 126 according to some embodiments. As illustrated herein, the media content 126 is stored along with the metadata 126a that includes a variety of information related to the media content 126. The metadata 126a may be part of the media content 126, for example, being generated by being encoded along with the media content 126, or may be associated with the corresponding media content 126 but stored separately from the media content 126. As illustrated herein, the metadata 126a may include: duration information 126aa that indicates duration, namely, the total playback time period from the start to the end; sampling rate information 126ab that indicates the sampling rate at which audio and/or video of the media content 126 is sampled; date-of-production information 126ac that indicates the date on which the media content 126 was created.

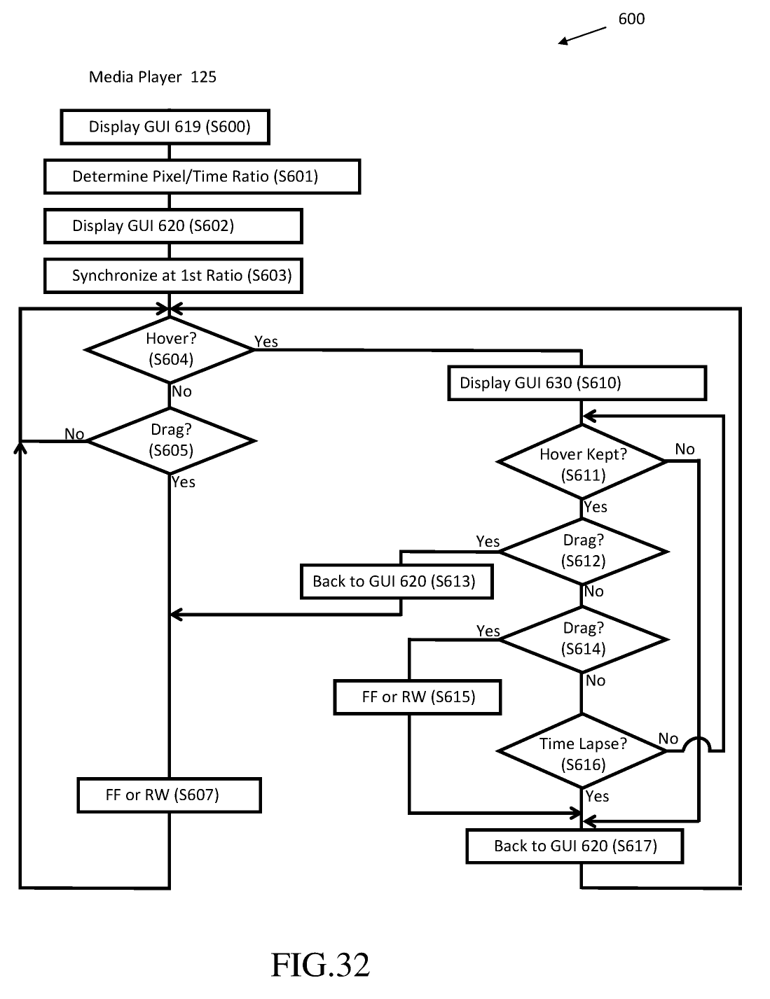

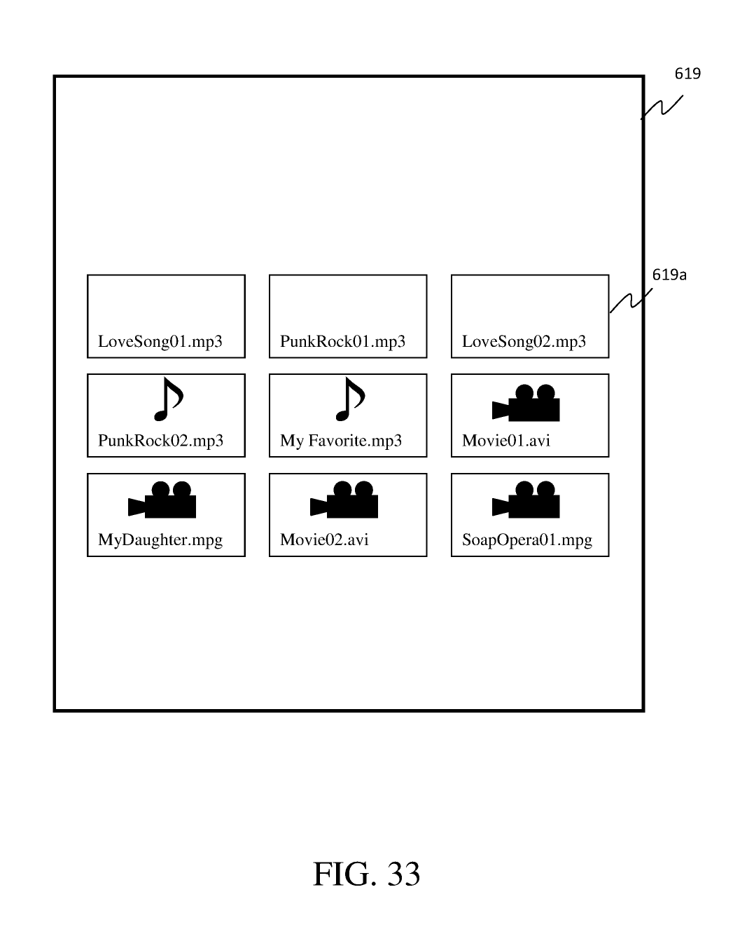

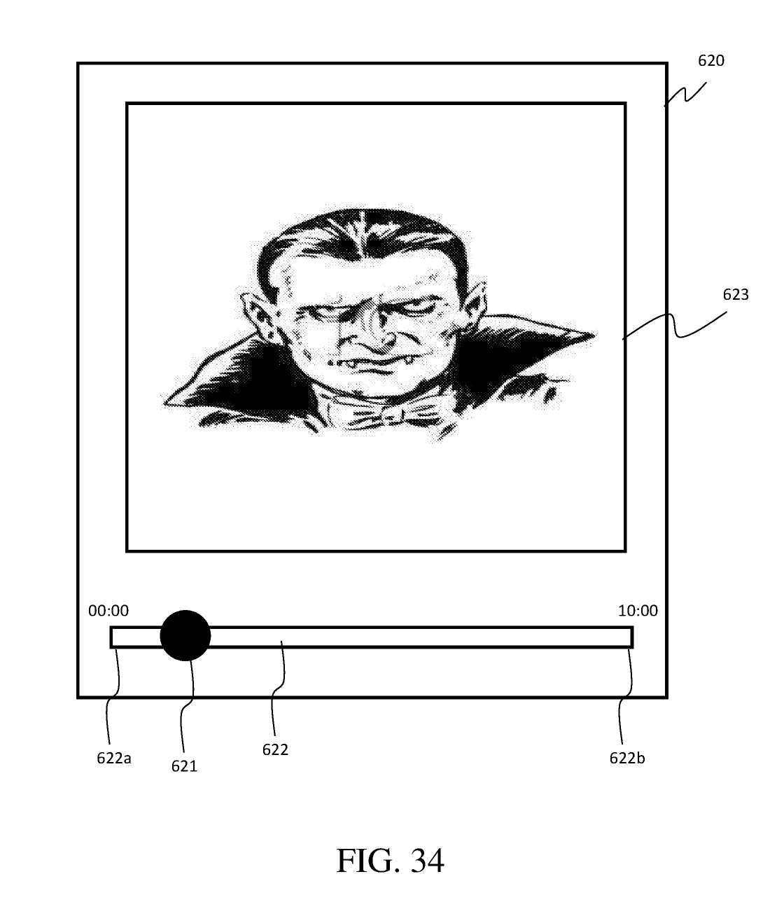

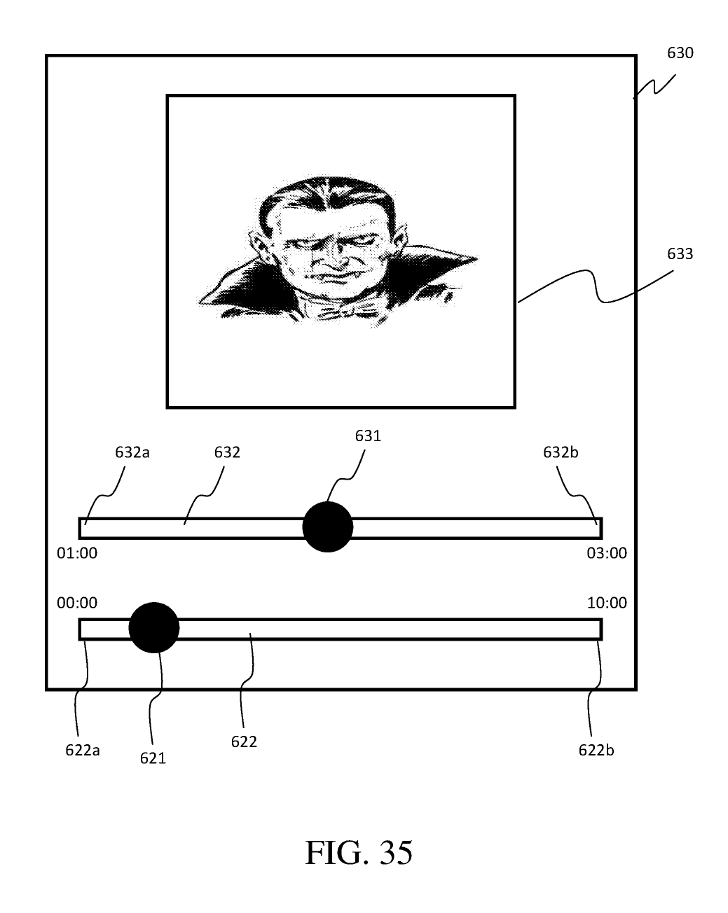

FIG. 32 is a flowchart illustrating a method 600 for an improved graphical user interface (GUI) of the media player 125 for fast-forwarding or rewinding playback of the media content 126 using progress bars, according to some embodiments. The media player 125 may include at least three GUIs: a GUI 619 for presenting the media contents 126, through which for a user to select one of the media contents 126 for playback, as depicted in FIG. 33; a GUI 620 for providing playback of the selected media content along with a first progress bar 622, through which for the user to watch the played-back media content 126 and control the playback of the media content 126 using the first progress bar 622, as depicted in FIG. 34; and a GUI 630 for providing playback of the selected media content along with the first progress bar 622 and an additional second progress bar 632, through which for the user to watch the played-back media content 126 and control the playback of the media content 126 using the first and second progress bars 622, 632, as depicted in FIGS. 35, 36, and 37.

As illustrated in FIG. 33, the GUI 619 may include presentation or listing of icons 619a each of which corresponds to a specific one of the media contents 126 so as for a user to select one of the icons 619a by tapping the icon using the input 107 to select a media content corresponding to the icon. The GUI 619 may proceed to the GUI 620 upon the selection of the media content.

As illustrated in FIG. 34, the GUI 620 may include playback field 623 in which playback of the media content 126 selected through the GUI 619 is presented; and the first progress bar 622 arranged adjacent to the playback filed 623. While the progress bar 622 is arranged below the playback filed 623 in an example shown in FIG. 34, the progress bar 622 may be arranged in any way in the GUI 620, for example, above the playback field 623 or at the left or right of playback field 623. The progress bar 622 may have a predetermined length or size extending from the start point 622a to the end point 622b. The length of the progress bar 622 may be defined dependent on the resolution or the number of pixels in the screen of the GUI 620, specifically dependent on the pixel density or the number of pixels in the row or column along which the progress bar 622 is arranged. For example, the length may be preset to be of 600 pixels when the screen of the GUI 620 has a 650 pixel row along which the progress bar 622 is arranged, namely, has the length extending from the start point 622a to the end point 622b. The progress bar 622 may further have a knob 621 that is a user interface element to be tapped and dragged by the user using the input 107. The knob 621 synchronizes with progress of playback of the media content 126 by automatically moving the knob 621 in the direction from the start point 622a to the end point 622b. In other words, the position of the knob 621 in the duration corresponds to or indicates the current playback position in the duration. In addition to the synchronization, the knob 621 may be moved manually in response to a user input using the input 107 to drag the knob 621 along the direction of length. The manual motion of the knob 621 in the first direction from the start point 622a to the end point 622b may invoke fast-forwarding of the playback whereas the manual motion of the knob 621 in the second direction from the end point 622b to the start point 622a may invoke rewinding of the playback.

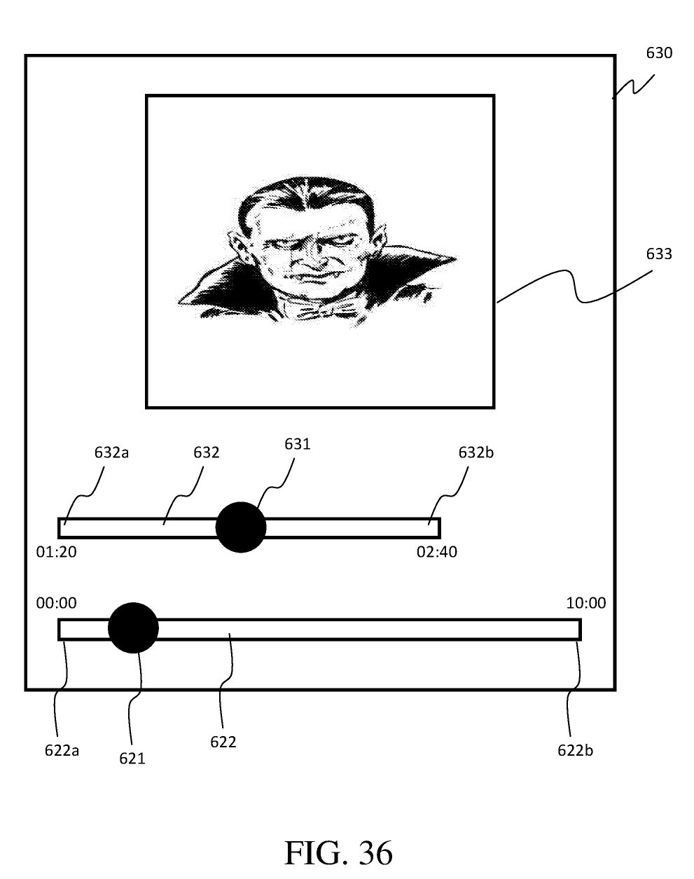

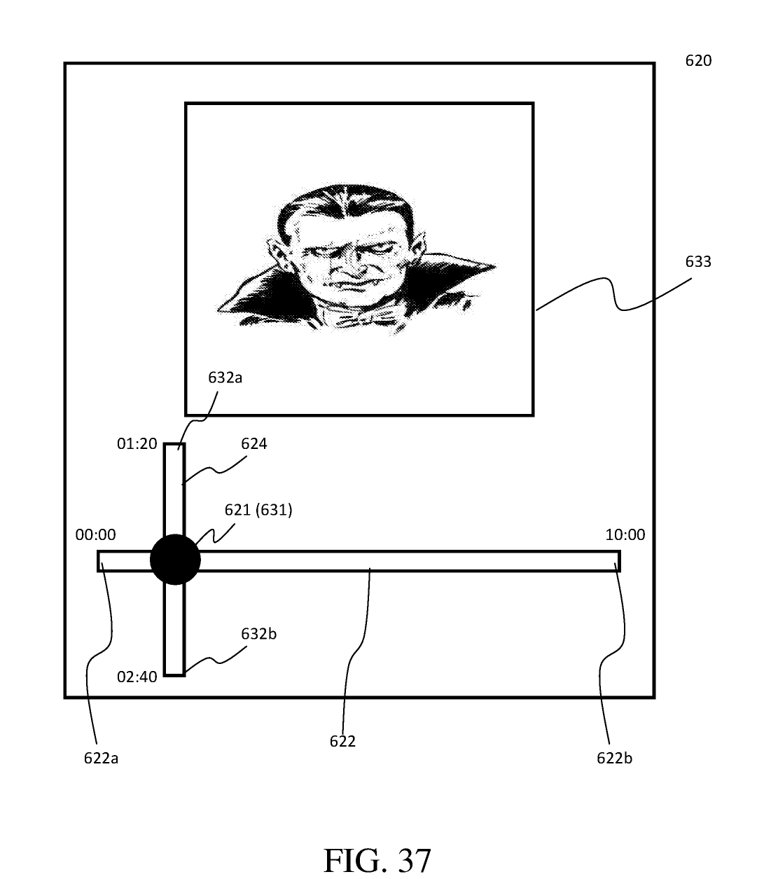

As illustrated in FIGS. 35, 36, and 37, the GUI 630 may include the second progress bar 632 in addition to the first progress bar 622. The second progress bar 632 appears or pops up in response to detection that a physical object such as a user's finger is hovering above the knob 621 of the first progress bar 622 for more than a first predetermined time period (e.g., one second or two seconds). In other words, the GUI 620 may proceed to the GUI 630 upon the detection of the hover. Similar to the first progress bar 622, the second progress bar 632 has the length or size extending from the start point 632a to the end point 632b and includes a knob 631 that is manually movable along the length in response to a user input using the input 107 to drag the knob 631. As illustrated in FIGS. 35 and 36, the second progress bar 632 may be appear or pop up a given pixels away from the first progress bar 622 toward the playback field 632, namely, at an area between the playback field 632 and the first progress bar 622. The second progress bar 632 may be arranged separately from and substantially in parallel to the first progress bar 622, namely, may have the length extending from the start point 632a to the end point 632b substantially in parallel to the length of the first progress bar 622 extending from the start point 622a to the end point 622b, as illustrated in FIGS. 35 and 36. Alternatively, as illustrated in FIG. 37, the second progress bar 632 may be arranged substantially perpendicularly to or orthogonally to the progress bar 622, namely, may have the length extending from the start point 632a to the end point 632b substantially perpendicularly to or orthogonally to the length of the first progress bar 622 extending from the start point 622a to the end point 622b, so that the knobs 632 and 622 are integrated with each other, namely, are displayed as one. The length of the second progress bar 632 may be defined in any way irrespective of the length of the first progress bar 622. As illustrated in FIG. 35, the second progress bar 632 may have substantially the same length as the first progress bar 632 does. Alternatively, as illustrated in FIG. 36, the second progress bar 632 may have a shorter length than the first progress bar 622 does.

Referring back to FIG. 32, the method 600 includes the media player 125 displaying the GUI 619 and receiving a user input through the input 107 to select one of the media contents 126 through the GUI 619 (S600). At the step S600, the media player 125 presents or lists the icons 619a corresponding to the media contents 126 stored on the memory 126 so as for the user to select one of the media contents 126 by tapping on a corresponding icon 619a using the input 107.

The method 600 further includes the media player 125 determining first and second pixel/time ratios that define how many pixels the knobs 621 and 631, respectively, can move per a unit of time (e.g., second) (S601). At the step S601, the first pixel/time ratio for the knob 621 may be determined depending on the duration of the selected media content 126 (the media content to be played back in the playback field 623) and the predetermined length of the progress bar 622. At the step S601, the media player 125 may obtain the duration (e.g., 10 minutes that is equal to 600 seconds) of the selected media content 126 by referring to the duration information 126aa in the metadata 126a associated with the selected media content 126; dividing the predetermined length (e.g., 1,200 pixels) by the obtained duration (e.g., 600 seconds) of the media content 126 to obtain the first pixel/time ratio (2 pixels per second). At the step S601, the second pixel/time ratio for the knob 631 is determined to be one that is larger or greater than the first pixel/time ratio. At the step S601, the media player 125 may multiply the first pixel/time ratio (e.g., 2 pixels per second) by N that is a number greater than 1 (e.g., 5) or adding the first pixel/time ratio (e.g., 2 pixels per second) with M that is a natural number greater than 0 (e.g., 8), to obtain the second pixel/time ratio (e.g., 10 pixels per second).

The method 600 may further include the media player 125 displaying the GUI 620, namely, switching a graphical user interface from the GUI 619 to GUI 620 (S602). At the step S602, the media player 125 plays back the selected media content 126; presents the playback in the playback field 623; and displays the progress bar 622. As illustrated in FIG. 34, the media player 125 may, with reference to the duration (e.g., 10 minutes as discussed above) of the media content 126, display the start time (e.g., 00:00) of the duration at the start point 622a as well as display the end time (e.g., 10:00) of the duration at the end point 622b.

The method 600 further includes the media player 125, during the playback, synchronizing the knob 621 with progress of the playback at the first pixel/time ratio (S603). At the step S603, the media player 125 may automatically move the knob 621 forward in the direction toward the end point 622b at the first pixel/time ratio (e.g., 2 pixels per second) according to progress of the playback.

The method 600 further includes the media player 125, during the display of the GUI 620, continuously determining whether or not the physical object such as the user's finger is hovering above the knob 621 based on detection of such hover by the sensitive display 106, 107 (S604).

The method 600 further includes the media player 125, as long as the determination at the step S602 is negative (S604: No), continuously determining whether or not drag is made on the knob 621 toward the end point 622b or the start point 622a on the basis of detection of tap(s) by the sensitive display 106, 107 (S605).

The method 600 further includes the media player 125, upon determining affirmatively at the step S605 (S605: Yes), fast-forwarding or rewinding the playback according to the first pixel/time ratio (S607). At the step S607, the media player 125 refers to the magnitude or pixels of the motion of the knob 621 (e.g., 100 pixels) as the result of the drag, and moves the playback position in the duration forward or back by a corresponding time (e.g., 50 seconds) according to the first pixel/time ratio (e.g., 2 pixels per second). The media player 125 fast-forwards the playback by moving the playback position forward upon determining that the knob 621 has been dragged toward the end point 622b at the step S605 whereas rewinds the playback by moving the playback position back upon determining that the knob 621 has been dragged toward the start point 622a at the step S605.

The method 600 further includes the media player 125, upon determining affirmatively at the step S604, namely, determining that the physical object such as the user's finger is hovering above the knob 621 for more than the predetermined time period, displaying the GUI 630, namely, switching a graphical user interface from the GUI 620 to GUI 630 (S610). At the step S610, the media player 125 displays or pops up the second progress bar 632 in response to the affirmative determination at the step S604. At the step S610, the media player 125 may determine a time period corresponding to part of the duration (e.g., 10 minutes) of the media content 126 as the total temporal range within which fast-forwarding and rewinding can be performed using the knob 631, on the basis of the second pixel/time ratio and the length of the second progress bar 632. More specifically, the media player 125 may determine the total temporal range by dividing the length (e.g., 1,200 pixels) of the second progress bar 632 by the number of pixels (e.g., 10 pixels) per unit of time (e.g., second) according to the second pixel/time ratio (e.g., 10 pixels per second). At the step S610, the media player 125 may then determine the start time and end time of the total temporal range on the basis of the total temporal range and the current playback position that corresponds to the position of the knob 621 above which the hover has been determined to be present at the step S604, More specifically, the media player 125 may determine the start time (Ts) that is chronologically previous to the current playback position (Tc) by a first give time period (T1 that is less than the total temporal range) as well as determine the end time (Te) that is chronologically later than or subsequent to the current playback time (Tc) by a second give time period (T2 that is defined as being the difference between the total temporal range and T1, namely, subtraction of T1 from the total temporal range). The start time (Ts) of the second progress bar 632 corresponds to the temporal position in the duration to which rewinding can be performed using the knob 631 of the second progress bar 632 whereas the end time (Te) corresponds to the temporal position in the duration to which fast-forwarding can be performed using the knob 631. In an example as illustrated in FIG. 35 where the total temporal range of the second progress bar 632 is determined to be 120 seconds (2 minutes) and the current playback position (Tc) is 02:00 in the duration from 00:00 to 10:00, the start time (Ts) may be set as 01:00 that is previous to 02:00 by T1 of 1 minute while the end time (Te) may be set as 03:00 that is subsequent to 02:00 by T2 of 1 minute. In examples as illustrated in FIGS. 36 and 37 where the total temporal range of the second progress bar 632 is determined to be 80 seconds (1 minute plus 20 seconds) and the current playback position (Tc) is 02:00 in the duration from 00:00 to 10:00, the start time (Ts) may be set as 01:20 that is previous to 02:00 by T1 of 40 seconds while the end time (Te) may be set as 02:40 that is subsequent to 02:00 by T2 of 40 seconds. At the step S610, the media player 125 may display the start time (Ts) at the start point 632a as well as display the end time (Te) at the end point 632b, as illustrated in FIGS. 35, 36, and 37. Preferably, at the step S610, the media player 125 may position the knob 631 substantially at the center of the progress bar 632 so that T1 is substantially equal to T2, which may be advantageous in that the range (T1) within which fast-forwarding can be performed by the forward motion of the knob 631 is substantially equal to the range (T2) within which rewinding can be performed by the backward motion of the knob 631, as illustrated in FIGS. 35, 36, and 37.

The method 600 further includes the media player 125, during the display of the GUI 730, continuously determining whether or not the physical object such as the user's finger is continuously hovering above the screen of GUI 630 on the basis of detection of such hover by the sensitive display 106, 107 (S611). The media player 125 displays the GUI 620, namely, switches the graphical user interface from the GUI 630 back to the GUI 620 upon determining negatively, namely, that hovering of the physical object such as the user's finger has been ceased at the step S611 (S611: No).

The method 600 further includes the media player 125, while the hovering of the physical object such as the user's finger is kept above the GUI 630, continuously determining whether or not the knob 621 of the first progress bar 622 is dragged on the basis of detection of tap(s) by the sensitive display 106, 107 (S612) and continuously determining whether or not the knob 631 of the second progress bar 632 is dragged on the basis of detection of tap(s) by the sensitive display 106, 107 (S614). In response to the knob 621 being dragged toward the end point 622a or the start point 622b (S612: Yes), the media player 125 displays the GUI 620, namely, switches the graphical user interface form the GUI 630 to GUI 620 by stopping display of the second progress bar 632 (S613), and performs the fast-forwarding or rewinding based on the first progress bar 622 according to the step S607. The switch of the graphical user interface at the step S613 is on the ground that the second progress bar 632 is no longer necessary because the user has chose to use the first progress bar 622 instead of using the second progress bar 632 for fast-forwarding or rewinding.

The method 600 further include the media player 125, in response to the knob 631 being dragged toward the end point 632b or the start point 632a (S614: Yes), fast-forwarding or rewinding the playback according to the second pixel/time ratio (S615). At the step S615, the media player 125 refers to the magnitude or pixels of the motion of the knob 631 (e.g., 100 pixels) as the result of the drag, and moves the playback position in the duration forward or backward by a corresponding time (e.g., 10 seconds) according to the second pixel/time ratio (e.g., 10 pixels per second). At the step S615, the media player 125 may synchronize the knob 621 of the first progress bar 622 with the forward or backward motion of playback position using the second progress bar 632, namely, may move the knob 621 toward the end point 622b or the start point 622a by pixel(s) (e.g., 20 pixels) that corresponds to the fast-forwarded or rewound time amount (e.g., 10 seconds) according to the first pixel/time ration (e.g., 2 pixels per second). Upon the fast-forwarding or rewinding at the step S615, the media player 125 goes to the step S617 to switch the graphical user interface from the GUI 630 to GUI 620 by stopping the display of the second progress bar 632.

The method 600 further includes the media player 125 determining whether or not a predetermined time period has passed by counting the predetermined time period while the physical object such as the user's finger is hovering above the screen of the GUI 630 (S611: Yes) and no dragging is detected on the knob 621 or 631 (S612: No, S614: No) (S616). In response to determining that the predetermined time has lapsed (S616:Yes), the media player 125 switches the graphical user interface from the GUI 630 to GUI 620 by stopping the display of the second progress bar 632 (S617).

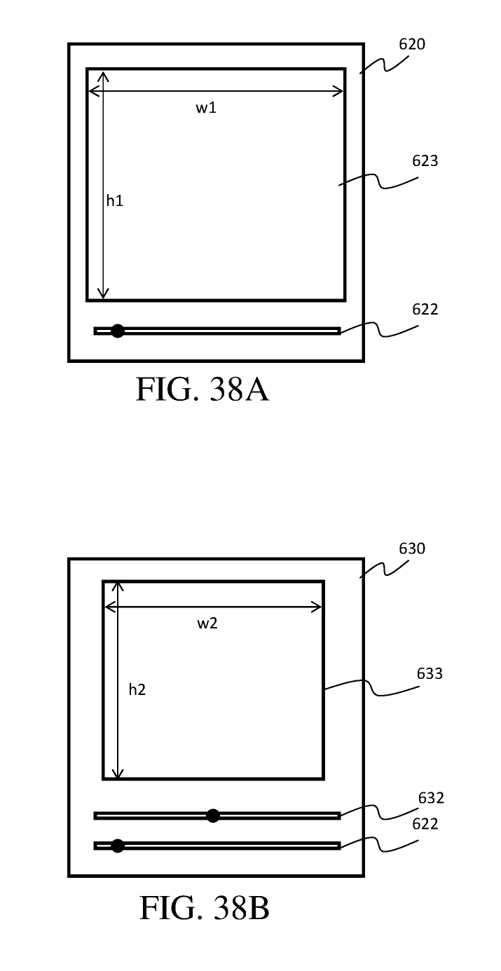

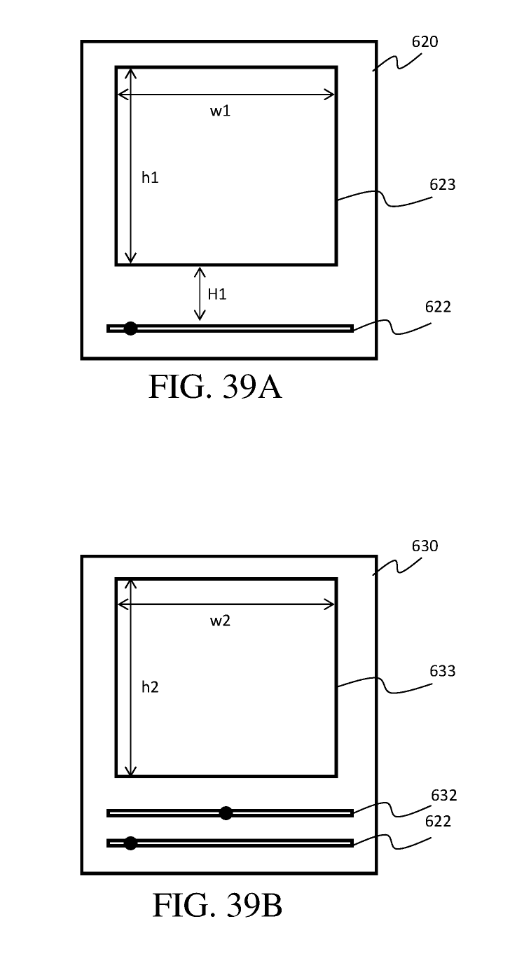

For performance of the method 600, the media player 125 is configured, namely, includes computer program instructions for performing the steps S600 through S617. For performance of the method 600, the media player 125 may have the playback filed 623 of GUI 620 with a first size (h1*w1) and the playback field 633 of GUI 630 with a second size (h2*w2) that is smaller than the first size, as illustrated in FIGS. 38A and 38B. In other words, the media player 125 may automatically change the playback field in size from h1*w1 to h2*w2 in response to switching the graphical user interface from the GUI 620 to GUI 630, and also reversely from h2*w2 to h1*w1 in response to switching the graphical user interface from the GUI 630 to GUI 620, so as for the popped-up second progress bar 632 is able to fit into or be accommodated in an area between the playback field 633 and the first progress bar 622. This aspect may be advantageous in that the playback filed 623 in the GUI 620 without the second progress bar 632 can be large as possible. On the other hand, for performance of the method 600, the media player 125 may have the playback field 623 of the GUI 620 with a first size (h1*w1) and the playback field 633 of GUI 630 with substantially the same size (h2*w2), as illustrated in FIGS. 39A and 39B. In other words, the GUI 620 may maintain a height (H1) between the playback field 623 and the first progress bar 622, namely, may keep the playback filed 623 spaced from the first progress bar 622 by H1, wherein the height H1 is long or great enough to accommodate the second progress bar 632. This aspect may be advantageous in that video displayed on the playback fields 623 and 633 is substantially unchanged or constant as the graphical user interfaces switches between the GUI 620 and GUI 630, which may make the user feel less uncomfortable. The method 600 may be advantageous in that the user is able to make detailed control of playback, namely, fast-forward or rewind playback within a short time frame that is part of the duration of the media content 126 using the second progress bar 632.

### <Note>

Further modifications and alternative embodiments will be apparent to those skilled in the art in view of this disclosure. Accordingly, the above description is to be construed as illustrative only and is for the purpose of teaching those skilled in the art a manner of carrying out the invention. It is to be understood that the forms of the invention herein shown and described are to be taken as exemplary embodiments. Various modifications may be made without departing from the scope of the invention. For example, equivalent elements or materials may be substitute for those illustrated and described herein, and certain features of the invention may be utilized independently of the use of other features, all as would be apparent to one skilled in the art after having the benefit of this description of the invention. In addition, the terms “a” and “an” are generally used in the present disclosure to mean one or more.

What is claimed is:

1. A method, comprising:
providing a first WWW browser on a first computing device;
providing a second WWW browser on a second computing device that is communicatable with the first computing device over network;
receiving a user input to request for download of a content from an online resource, by the first WWW browser through a WWW page rendered on the first WWW browser;
issuing a download request by the first WWW browser to the second WWW browser over the network, wherein the download request requests the second WWW browser to download the content locally onto the second computing device; and
in response to the download request, accessing to the online resource and download the content over the network by the second WWW browser to store the content locally onto the second computing device.
